(19) United States
(12) Patent Application Publication
(10) Pub. No.: US 2018/0009959 A1
(43) Pub. Date: Jan. 11, 2018

(54) HARD COAT LAMINATE FILM

(71) Applicant: RIKEN TECHNOS CORPORATION, Tokyo (JP)

(72) Inventors: Kohei NAKASHIMA, Tokyo (JP); Hideaki YAMBE, Tokyo (JP)

(73) Assignee: RIKEN TECHNOS CORPORATION, Tokyo (JP)

(21) Appl. No.: 15/533,286

(22) PCT Filed: Oct. 2, 2015
(86) PCT No.: PCT/JP2015/078044

§ 371 Date: Jun. 5, 2017

(30) Foreign Application Priority Data
Dec. 5, 2014 (JP) 2014-246963

(51) Int. Cl. C08J 7/04; C09D 133/10; B05D 3/14; B29K 69/00; B29C 47/00; B05D 1/26

(52) U.S. Cl. CPC C08J 7/047; C09D 133/10; C08J 7/042; C08J 2433/10; C08J 2369/00; B05D 1/265; B29K 2995/0026; B29K 2069/00; B29C 47/0021; B05D 3/142; C08J 2433/26

(57) ABSTRACT

According to at least one embodiment, there is provided a hard coat laminate film having a total light transmittance of 80% or more and having (γ) a hard coat on at least one surface of (α) an aromatic-polycarbonate resin film containing 30 mol % or more of a structural unit derived from 4,4′-(3,3,5-trimethylcyclohexane-1,1-diyl)diphenol when the total of the structural units derived from aromatic dihydroxy compounds is 100 mol %. According to another embodiment, there is provided a hard coat laminate film having a total light transmittance of 80% or more and having (γ) a hard coat on at least one surface of a transparent laminate film constituted of (α) an aromatic-polycarbonate resin film containing 30 mol % or more of a structural unit derived from 4,4′-(3,3,5-trimethylcyclohexane-1,1-diyl)diphenol, when the total of the structural units derived from aromatic dihydroxy compounds is 100 mol %, and (β) a poly(meth)acrylimide resin film.

### CROSS REFERENCE TO RELATED APPLICATIONS

This application claims the benefit of and priority to PCT/JP2015/078044, filed on Oct. 2, 2015, entitled (translation), “HARD COAT LAMINATE FILM,” which claims the benefit of and priority to Japanese Patent Application No. 2014-246963, filed on Dec. 5, 2014, each of which is hereby incorporated by reference in their entirety into this application.

### BACKGROUND

### Field

Embodiments of the invention relate to a hard coat-laminated film. In particular, embodiments relate to a laminated film excellent in thermal resistance made from an aromatic polycarbonate resin film and a hard coat.

### Description of Related Art

In recent years, there have spread touch panels which are installed on image display apparatuses such as liquid crystal displays, plasma displays and electroluminescence displays and on which inputting can be carried out by touch with a finger, a pen or the like with the display being looked at.

Further, for substrates for image display apparatuses (including image display apparatuses having a touch panel function and image display apparatuses having no touch panel function) on which circuits are formed and various devices are arranged, there have been used articles with a glass substrate since conforming to required properties such as heat resistance, dimensional stability, high transparency, high surface hardness and high rigidity.

However, glass has problems such as being low in impact resistance and liable to break; being low in workability; being difficult to handle; having a high specific gravity and being heavy; and being difficult to meet requirements of face curving and flexibilizing of displays. Particularly in mobile terminals such as smartphones and tablet computers, being heavy is a large drawback of being prone to spoil their marketability.

Then, there have been proposed touch panels (so-called one glass solution) having a two-layer structure in which a touch sensor is formed directly on the rear side of a display face plate. The touch panels are, however, still heavy for mobile terminals as long as using glass, and the proposals are thus insufficient. Further, the proposals do not solve in any way problems of impact resistance, workability and handleability. Further, the proposals do not meet requirements of face curving and flexibilizing.

Further, a large number of resin films excellent in thermal resistance and dimensional stability have been proposed as materials in place of glass (for example, see JP 2014-168943 A and JP 2014-019108 A). However, the surface hardness and rigidity thereof are insufficient, and applications thereof to the one plastic solution in place of the so-called one glass solution have not been expected.

### SUMMARY

According to at least one embodiment, there is provided a hard coat-laminated film being excellent in thermal resistance, dimensional stability, transparency, surface hardness and rigidity, and being capable of being used suitably as a substrate for image display apparatuses (including image display apparatuses having a touch panel function and image display apparatuses having no touch panel function) on which circuits are formed and various devices are arranged. According to another embodiment, there is provided a hard coat-laminated film applicable to the one plastic solution in place of the so-called one glass solution.

According to at least one embodiment, there is provided a hard coat-laminated film, including: (α) an aromatic polycarbonate resin film comprising a structural unit derived from 4,4′-(3,3,5-trimethylcyclohexane-1,1-diyl)diphenol in an amount of 30% by mol or larger with the total amount of a structural unit(s) derived from an aromatic dihydroxy compound(s) being taken to be 100% by mol; and (γ) a hard coat formed on at least one surface of the aromatic polycarbonate resin film, wherein the hard coat-laminated film has a total light transmittance of 80% or higher.

According to another embodiment, there is provided a hard coat-laminated film, including: a transparent laminated film of (α) an aromatic polycarbonate resin film comprising a structural unit derived from 4,4′-(3,3,5-trimethylcyclohexane-1,1-diyl)diphenol in an amount of 30% by mol or larger with the total amount of a structural unit derived from an aromatic dihydroxy compound being taken to be 100% by mol, with (β) a poly(meth)acrylimide resin film; and (γ) a hard coat formed on at least one surface of the transparent laminated film, wherein the hard coat-laminated film has a total light transmittance of 80% or higher.

According to at least one embodiment, the laminated film is formed by laminating the (β) a poly(meth)acrylimide resin film, the (α) aromatic polycarbonate resin film and the (β) poly(meth)acrylimide resin film in this order.

According to at least one embodiment, the (γ) hard coat is formed from an active energy ray-curable resin composition including: (A) 100 parts by mass of a polyfunctional (meth)acrylate; (B) 0.2 to 4 parts by mass of a compound having an alkoxysilyl group and a (meth)acryloyl group; (C) 0.05 to 3 parts by mass of an organotitanium; and (D) 5 to 100 parts by mass of microparticles having an average particle diameter of 1 to 300 nm.

According to at least one embodiment, the active energy ray-curable resin composition further includes (E) 0.01 to 7 parts by mass of a water repellant.

According to at least one embodiment, the (E) water repellant includes a (meth)acryloyl group-containing fluoropolyether water repellant.

According to another embodiment, there is provided a hard coat-laminated film, having, in order from the outermost surface layer side: (γ1) a first hard coat; (β) a poly(meth)acrylimide resin layer; (α) an aromatic polycarbonate resin layer including a structural unit derived from 4,4′-(3,3,5-trimethylcyclohexane-1,1-diyl)diphenol in an amount of 30% by mol or larger with the total amount of a structural unit(s) derived from an aromatic dihydroxy compound(s) being taken to be 100% by mol; and (γ2) a second hard coat, wherein the (γ1) first hard coat is formed from an active energy ray-curable resin composition including: (A) 100 parts by mass of a polyfunctional (meth)acrylate; (B) 0.2 to 4 parts by mass of a compound having an alkoxysilyl group and a (meth)acryloyl group; (C) 0.05 to 3 parts by mass of an organotitanium; (D) 5 to 100 parts by mass of microparticles having an average particle diameter of 1 to 300 nm; and (E) 0.01 to 7 parts by mass of a water repellant, and wherein the hard coat-laminated film has a total light transmittance of 80% or higher.

According to at least one embodiment, the hard coat-laminated film further includes (β) another poly(meth)acrylimide resin layer between the (α) aromatic polycarbonate resin layer and the (γ2) second hard coat.

According to at least one embodiment, the hard coat-laminated film further includes (δ) a gas barrier functional layer.

According to at least one embodiment, there is provide use of the hard coat-laminated film as an image display apparatus member.

According to at least one embodiment, there is provided an image display apparatus, including the hard coat-laminated film discussed above.

### BRIEF DESCRIPTION OF DRAWINGS

FIG. 1 is a conceptual view illustrating one example of the hard coat-laminated film according to an embodiment.

FIG. 2 is a DEPT135 spectrum and a ¹³C-NMR spectrum (15 to 55 ppm) of (α-2) used in Examples.

FIG. 3 is a DEPT135 spectrum and a ¹³C-NMR spectrum (110 to 160 ppm) of (α-2) used in Examples.

FIG. 4 is a ¹H-NMR spectrum of (α-1) used in Examples.

### DETAILED DESCRIPTION

The term “resin” is herein used to include a “resin mixture containing two or more resins” and a “resin composition containing a component(s) other than resins”. The term “film” is herein used to include a “sheet” as well.

(α) Aromatic Polycarbonate Resin Film

The hard coat-laminated film according to at least one embodiment includes: as a film substrate, (α) an aromatic polycarbonate resin film in which the content of a structural unit (hereinafter, abbreviated to “BPTMC” in some cases) derived from 4,4′-(3,3,5-trimethylcyclohexane-1,1-diyl)diphenol is 30% by mol or larger with the total amount of a structural unit(s) derived from an aromatic dihydroxy compound(s) being taken to be 100% by mol; and (γ) a hard coat formed directly or through another layer on at least one surface of the aromatic polycarbonate resin film.

According to at least one embodiment, the (α) aromatic polycarbonate resin includes, with the total amount of a structural unit(s) derived from an aromatic dihydroxy compound(s) being taken to be 100% by mol, 30% by mol or larger of BPTMC, preferably 40% by mol or larger thereof, and more preferably 50% by mol or larger thereof. On the other hand, the upper limit amount of BPTMC in the (α) aromatic polycarbonate resin is not especially limited, and may be made to be, with the total amount of a structural unit(s) derived from an aromatic dihydroxy compound(s) being taken to be 100% by mol, 100% by mol or smaller of BPTMC, or 98% by mol or smaller thereof, and may be more typically made to be 95% by mol or smaller thereof.

According to at least one embodiment, the (α) aromatic polycarbonate resin more preferably includes BPTMC in an amount of 50 to 98% by mol and a structural unit (hereinafter, abbreviated to “BPA” in some cases) derived from bisphenol A in an amount of 50 to 2% by mol, and most preferably comprises BPTMC in an amount of 55 to 95% by mol and BPA in an amount of 45 to 5% by mol.

By using the aromatic polycarbonate resin film comprising BPTMC in an amount of 30% by mol or larger with the total amount of a structural unit(s) derived from an aromatic dihydroxy compound(s) being taken to be 100% by mol, the hard coat-laminated film according to at least one embodiment becomes one excellent in thermal resistance, dimensional stability and transparency. Here, the (α) aromatic polycarbonate resin may be a resin mixture containing two or more aromatic polycarbonate resins. In the case of being the resin mixture, it suffices if the BPTMC content in the mixture is made to be in the above-mentioned range.

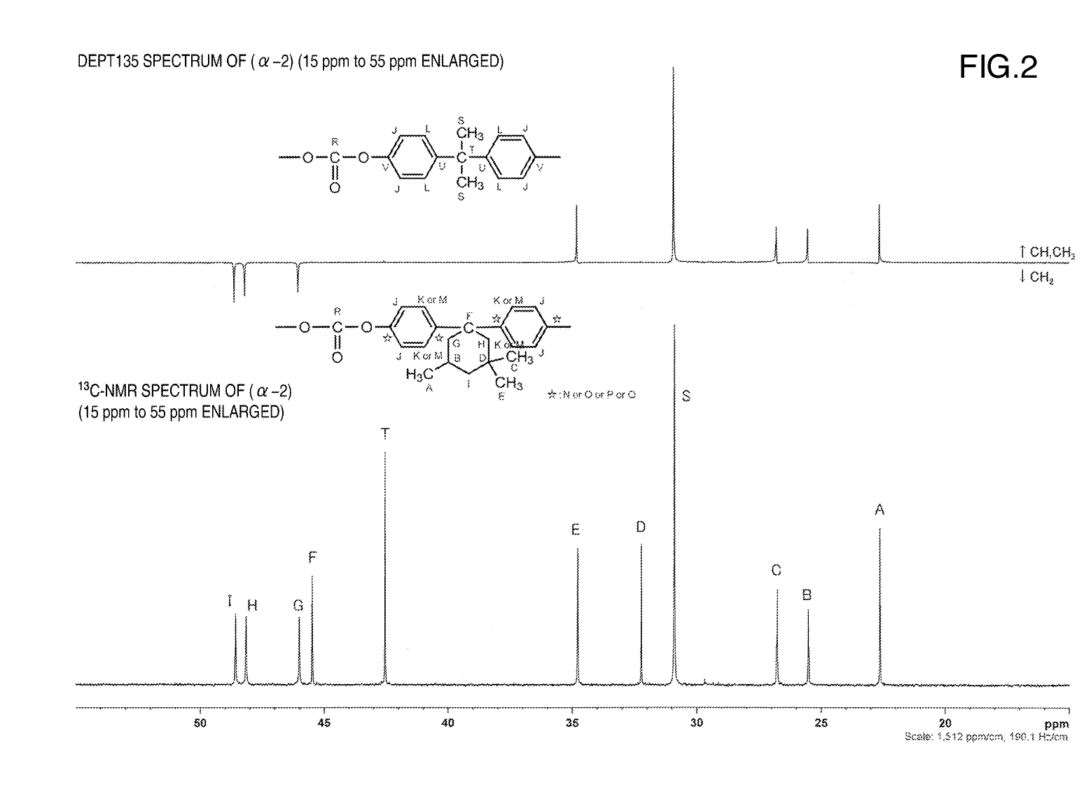

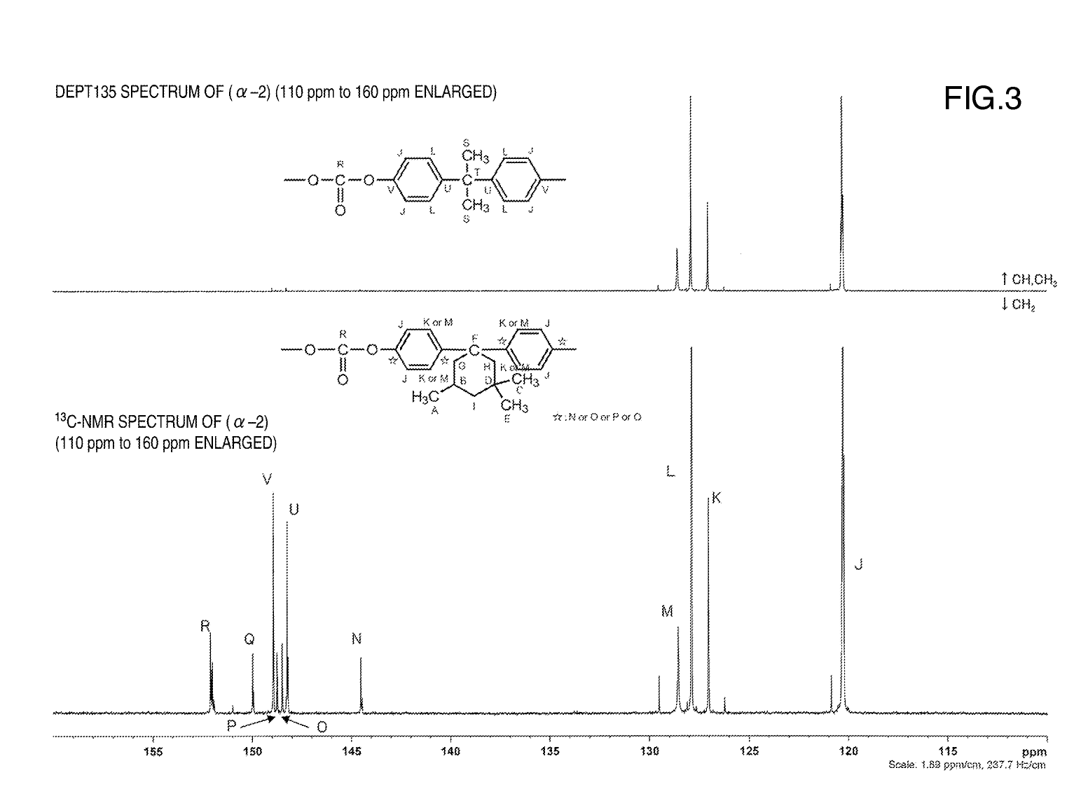

According to at least one embodiment, the content of the each structural unit such as the BPTMC content or the BPA content of the (α) aromatic polycarbonate resin can be determined by using ¹³C-NMR or ¹H-NMR. A ¹³C-NMR spectrum can be measured, for example, by dissolving 20 mg of a sample in 0.6 mL of a chloroform-d₁ solvent and using a nuclear magnetic resonance spectrometer at 125 MHz, and under the following condition. Measurement examples thereof are shown in FIGS. 2 and 3.

Chemical shift reference: chloroform-d₁: 77.0 ppm

Measurement mode: single-pulse proton broad-band decoupling

Pulse width: 45° (5.0 μs)

Number of points: 64K

Observation range: 250 ppm (−25 to 225 ppm)

Repeating time: 5.5 s

Number of integration: 256 times

Measurement temperature: 23° C.

Window function: exponential (BF: 1.0 Hz)

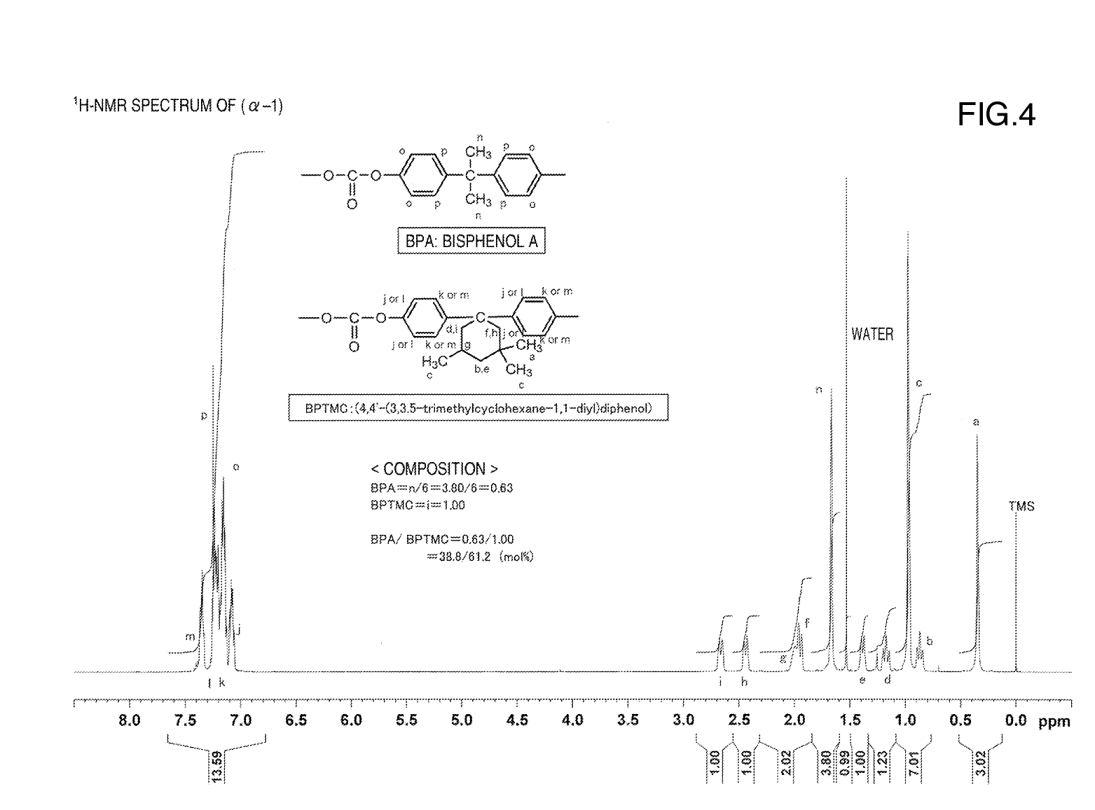

A ¹H-NMR spectrum can be measured, for example, by dissolving 20 mg of a sample in 0.6 mL of a chloroform-d₁ solvent and using a nuclear magnetic resonance spectrometer at 500 MHz, and under the following condition. A measurement example thereof is shown in FIG. 4.

Chemical shift reference: TMS: 0.0 ppm

Measurement mode: single pulse

Pulse width: 45° (5.0 μs)

Number of points: 32K

Measurement range: 20 ppm (−5 to 15 ppm)

Repeating time: 7.3 s

Number of integration: 8 times

Measurement temperature: 23° C.

Window function: exponential (BF: 0.18 Hz)

Assignments of peaks are carried out by reference to “Kobunshi Bunseki Handbook” (Polymer Analysis Handbook) (Sep. 20, 2008, first edition, first print, edited by The Japan Society for Analytical Chemistry, Discussion Group of Polymer Analysis, published by Asakura Publishing Co., Ltd.) and “the NMR data base on the material information station of National Institute for Materials Science (http://polymer.nims.go.jp/NMR/)”; and the proportion of each component in the (α) aromatic polycarbonate resin can be calculated from the peak area ratio. Here, the measurements of ¹³C-NMR and ¹H-NMR may be carried out in an analysis institute such as Mitsui Chemical Analysis & Consulting Service, Inc.

According to at least one embodiment, a method for producing the (α) aromatic polycarbonate resin is not especially limited, and the (α) aromatic polycarbonate resin can be obtained by a known method, for example, a method of interfacially polymerizing an aromatic dihydroxy compound such as 4,4′-(3,3,5-trimethylcyclohexane-1,1-diyl)diphenol and bisphenol A with phosgene; or a method of transesterifying an aromatic dihydroxy compound such as 4,4′-(3,3,5-trimethylcyclohexane-1,1-diyl)diphenol and bisphenol A with a carbonate diester such as diphenyl carbonate.

According to at least one embodiment, the (α) aromatic polycarbonate resin may further include, as required, an optional component(s) such as aromatic polycarbonate resins other than the (α) aromatic polycarbonate resin and thermoplastic resins such as core shell rubber; pigments, inorganic fillers, organic fillers, and resin fillers; and additives such as lubricants, antioxidants, weather resistance stabilizers, thermal stabilizers, mold release agents, antistatic agents and surfactants, within limits not contradictory to the objects of the present invention. Examples of the core shell rubber include methacrylate-styrene/butadiene rubber graft copolymers, acrylonitrile-styrene/butadiene rubber graft copolymers, acrylonitrile-styrene/ethylene-propylene rubber graft copolymers, acrylonitrile-styrene/acrylate graft copolymers, methacrylate/acrylate rubber graft copolymers and methacrylate-acrylonitrile/acrylate rubber graft copolymers. The blend amount of these optional components is usually about 0.01 to 10 parts by mass with the amount of the (α) aromatic polycarbonate resin being taken to be 100 parts by mass.

According to at least one embodiment, the thickness of the (α) aromatic polycarbonate resin film is not especially limited, and can be any thickness as required. In the case where the hard coat-laminated film according to at least one embodiment is applied to the one plastic solution, from the viewpoint of keeping the rigidity required as a display face plate, the thickness of the (α) aromatic polycarbonate resin film may be usually 100 μm or larger, preferably 200 μm or larger, and more preferably 300 μm or larger. Further, from the viewpoint of meeting the requirement of the thickness reduction of image display apparatuses, the thickness of the (α) aromatic polycarbonate resin film may be usually 1,500 μm or smaller, preferably 1,200 μm or smaller, and more preferably 1,000 μm or smaller. In the case where the hard coat-laminated film according to at least one embodiment is used as a usual substrate (i.e., a substrate not having a function as a display face plate), the thickness of the (α) aromatic polycarbonate resin film may be usually 20 um or larger, and preferably 50 um or larger, from the viewpoint of the handling properties. Further, from the viewpoint of the economic efficiency, the thickness of the (α) aromatic polycarbonate resin film may be usually 250 um or smaller, and preferably 150 um or smaller.

According to at least one embodiment, the (α) aromatic polycarbonate resin film has a total light transmittance of preferably 85% or higher, more preferably 90% or higher and still more preferably 92% or higher as measured according to JIS K7361-1:1997 by using a turbidimeter “NDH2000” (trade name) of Nippon Denshoku Industries Co., Ltd. A higher total light transmittance of the (α) aromatic polycarbonate resin film is preferable. When the resin film has such a high total light transmittance, there can be obtained the hard coat-laminated film capable of being used suitably as an image display apparatus member.

According to at least one embodiment, the (α) aromatic polycarbonate resin film has a haze of preferably 3.0% or lower, more preferably 2.0% or lower and still more preferably 1.5% or lower as measured according to JIS K7136:2000 by using a turbidimeter “NDH2000” (trade name) of Nippon Denshoku Industries Co., Ltd. A lower haze of the (α) aromatic polycarbonate resin film is preferable. When the resin film has such a low haze, there can be obtained the hard coat-laminated film capable of being used suitably as an image display apparatus member.

According to at least one embodiment, the (α) aromatic polycarbonate resin film has a yellowness index of preferably 3 or lower, more preferably 2 or lower and still more preferably 1 or lower as measured according to JIS K7105:1981 by using a chromaticity meter “SolidSpec-3700” (trade name) of Shimadzu Corp. A lower yellowness index of the (α) aromatic polycarbonate resin film is preferable. When the resin film has such a low yellowness index, there can be obtained the hard coat-laminated film capable of being used suitably as an image display apparatus member.

(β) Poly(Meth)Acrylimide Resin Film

In the case where the hard coat-laminated film according to at least one embodiment is applied to the one plastic solution, it is preferable that on at least one surface of the (α) aromatic polycarbonate resin film, preferably on the side acting as a touch surface of a touch panel, the (β) a poly(meth)acrylimide resin film is laminated. As an alternative embodiment, on both surfaces of the (α) aromatic polycarbonate resin film, the (β) poly(meth)acrylimide resin films may be laminated to form a transparent laminated film. The (α) aromatic polycarbonate resin is more excellent in thermal resistance and dimensional stability than the (β) poly(meth)acrylimide resin, and the (β) a poly(meth)acrylimide resin is more excellent in surface hardness and rigidity than the (α) aromatic polycarbonate resin. Hence, use of a transparent multilayer film having the above-mentioned layer structure as a film substrate to form the (γ) hard coat thereon can further enhance the thermal resistance, dimensional stability, surface hardness and rigidity of the hard coat-laminated film.

According to at least one embodiment, the (β) a poly(meth)acrylimide resin is a thermoplastic resin having characteristics as they are of high transparency, high surface hardness and high rigidity of acrylic resins, having introduced characteristics of being excellent in thermal resistance and dimensional stability of polyimide resins, and being improved in a drawback of coloration from light yellow to reddish brown. The (β) poly(meth)acrylimide resin is disclosed, for example, in JP2011-519999A. Here, the term poly(meth)acrylimide is herein intended to mean polyacrylimide or polymethacrylimide.

According to at least one embodiment, the (β) a poly(meth)acrylimide resin is not limited as long as having high transparency and exhibiting no coloration for the purpose of using the hard coat-laminated film for optical articles such as touch panels, and any poly(meth)acrylimide resins can be used.

According to at least one embodiment, the (β) a poly(meth)acrylimide resin has a yellowness index of preferably 3 or lower, more preferably 2 or lower and still more preferably 1 or lower as measured according to JIS K7105:1981 by using a chromaticity meter “SolidSpec-3700” (trade name) of Shimadzu Corp. Further, the melt mass flow rate (measured under the conditions of 260° C. and 98.07 N according to ISO 1133) of the (β) poly(meth)acrylimide resin is, from the viewpoint of the extrusion load, and the stability of the melted film, preferably 0.1 to 20 g/10 min, and more preferably 0.5 to 10 g/10 min. Further, the glass transition temperature of the (β) a poly(meth)acrylimide resin is preferably 150° C. or higher, and more preferably 170° C. or higher from the viewpoint of the thermal resistance.

According to at least one embodiment, the glass transition temperature referred to herein is an intermediate glass transition temperature acquired by using a Diamond DSC-type differential scanning calorimeter of PerkinElmer Japan Co., Ltd., and plotting and calculating, according to FIG. 2 of ASTM D3418, the glass transition emerging on a curve measured in the final temperature-rise process in a temperature program that a sample is heated at a temperature-rise rate of 50° C./min up to 300° C., held at 300° C. for 10 min, thereafter cooled at a temperature-fall rate of 20° C./min down to 50° C., held at 50° C. for 10 min and thereafter heated at a temperature-rise rate of 20° C./min up to 300° C.

According to at least one embodiment, the (β) a poly(meth)acrylimide resin can further include an optional component(s), as required, thermoplastic resins other than the (β) poly(meth)acrylimide resin; pigments, inorganic fillers, organic fillers, and resin fillers; and additives such as lubricants, antioxidants, weather resistance stabilizers, thermal stabilizers, mold release agents, antistatic agents and surfactants, within limits not contradictory to the objects of the present invention. The blend amount of the optional component(s) is usually about 0.01 to 10 parts by mass relative to 100 parts by mass of the (β) a poly(meth)acrylimide resin.

Commercially available examples of the poly(meth)acrylimide resin include “PLEXIMID TT70” (trade name) of Evonik Degussa GmbH.

According to at least one embodiment, the thickness of the (β) a poly(meth)acrylimide resin film is not especially limited, and can be any thickness as required. In the case where the hard coat-laminated film according to at least one embodiment is applied to the one plastic solution, from the viewpoint of the surface hardness and the rigidity, the thickness of the (β) poly(meth)acrylimide resin film may be usually 50 μm or larger, and preferably 100 μm or larger. Further from the viewpoint of meeting the requirement of the thickness reduction of image display apparatuses, and further from the viewpoint of the economic efficiency, the thickness of the (β) a poly(meth)acrylimide resin film may be usually 250 μm or smaller, and preferably 200 μm or smaller.

According to at least one embodiment, the (β) poly(meth)acrylimide resin film has a total light transmittance of preferably 85% or higher, more preferably 90% or higher and still more preferably 92% or higher as measured according to JIS K7361-1:1997 by using a turbidimeter “NDH2000” (trade name) of Nippon Denshoku Industries Co., Ltd. A higher total light transmittance of the (β) a poly(meth)acrylimide resin film is preferable. When the resin film has such a high total light transmittance, there can be obtained the hard coat-laminated film capable of being used suitably as an image display apparatus member.

According to at least one embodiment, the (β) poly(meth)acrylimide resin film has a haze of preferably 3.0% or lower, more preferably 2.0% or lower and still more preferably 1.5% or lower as measured according to JIS K7136:2000 by using a turbidimeter “NDH2000” (trade name) of Nippon Denshoku Industries Co., Ltd. A lower haze of the (β) a poly(meth)acrylimide resin film is preferable. When the resin film has such a low haze, there can be obtained the hard coat-laminated film capable of being used suitably as an image display apparatus member.

According to at least one embodiment, the (β) poly(meth)acrylimide resin film has a yellowness index of preferably 3 or lower, more preferably 2 or lower and still more preferably 1 or lower as measured according to JIS K7105:1981 by using a chromaticity meter “SolidSpec-3700” (trade name) of Shimadzu Corp. A lower yellowness index of the (β) poly(meth)acrylimide resin film is preferable. When the resin film has such a low yellowness index, there can be obtained the hard coat-laminated film capable of being used suitably as an image display apparatus member.

A method of laminating the (α) aromatic polycarbonate resin film and the (β) poly(meth)acrylimide resin film to produce a transparent laminated film is not especially limited and can be performed by any method. Examples thereof include a method in which the (α) aromatic polycarbonate resin film and the (β) a poly(meth)acrylimide resin film are each obtained by any method, and are thereafter laminated by using a transparent chemically curing adhesive or a transparent pressure-sensitive adhesive; a method in which the each constituting material is melted by an extruder, and a T-die coextrusion process with a feed block type apparatus, a multi-manifold type apparatus or a stack plate type apparatus is used; and an extrusion lamination method in which one of the (α) aromatic polycarbonate resin film and the (β) poly(meth)acrylimide resin film is obtained by any method, and thereafter, the other thereof is melt extruded on the one.

There will be described the case where the lamination of the (α) aromatic polycarbonate resin film and the (β) a poly(meth)acrylimide resin film is carried out by using a transparent chemically curing adhesive or a transparent pressure-sensitive adhesive.

A film(s) of a transparent chemically curing adhesive or a transparent pressure-sensitive adhesive can be formed on a laminate surface of the (α) aromatic polycarbonate resin film or/and a laminate surface of the (β) a poly(meth)acrylimide resin film, and the laminate surface of one of the both can be stacked on the laminate surface of the other and they can be then pressed to each other, by which a transparent laminated film can be obtained. When the laminate surfaces of the both are stacked, as required, there may be pre-heated the (α) aromatic polycarbonate resin film or/and the (β) poly(meth)acrylimide resin film. When the both are pressed, as required, a pressing roll and/or a receiving roll may be pre-heated. After the pressing, a post-treatment may be carried out by using an active energy ray irradiation furnace, a drying furnace or the like.

In the case where a transparent laminated film is produced from the (α) aromatic polycarbonate resin film and the (β) a poly(meth)acrylimide resin film, the laminate surface of the (α) aromatic polycarbonate resin film may previously be subjected to an easy-adhesion treatment such as corona discharge treatment or anchor coat formation. Or, a hard coat or (δ) a gas barrier functional layer may be formed on the laminate surface of the (α) aromatic polycarbonate resin film.

In the case where a transparent laminated film is produced from the (α) aromatic polycarbonate resin film and the (β) a poly(meth)acrylimide resin film each single, usually circuits may be formed or various devices may be arranged on the printing surface (i.e., the surface on the opposite side to the laminate surface) of the (α) aromatic polycarbonate resin film. The formation of the circuits and the arrangement of the devices may be carried out before the lamination or after the lamination.

According to at least one embodiment, the laminate surface of the (β) poly(meth)acrylimide resin film may previously be subjected to an easy-adhesion treatment such as corona discharge treatment or anchor coat formation. Or, a hard coat or (δ) a gas barrier functional layer may be formed on the laminate surface of the (β) a poly(meth)acrylimide resin film. On the touch surface (i. e., the surface on the opposite side to the laminate surface) of the (β) a poly(meth)acrylimide resin film, usually, a hard coat for the touch surface may be formed. The hard coat for the touch surface may be formed before the lamination, or may be formed after the lamination. Further, the (δ) gas barrier functional layer may be formed on the touch surface of the (β) a poly(meth)acrylimide resin film, and then a hard coat for the touch surface may be formed thereon.

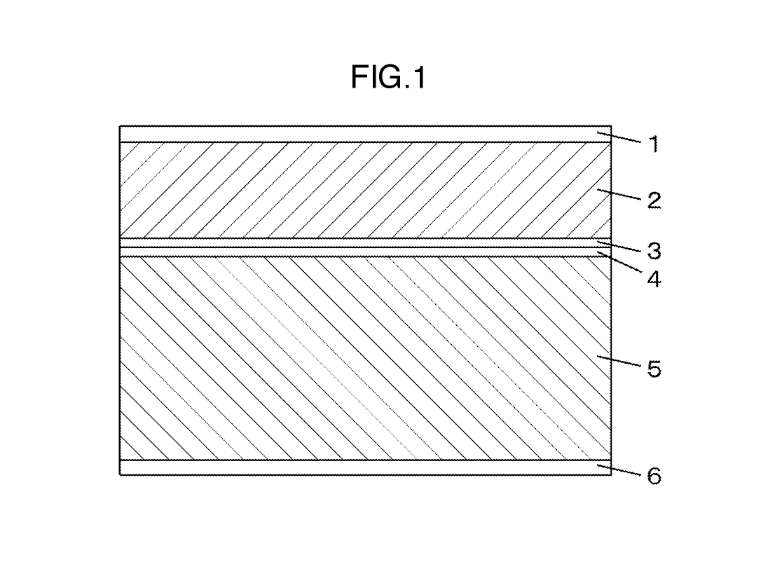

FIG. 1 shows one typical example of the hard coat-laminated film according to an embodiment of the invention. This hard coat-laminated film has, in order from the outermost surface layer side, 1: (γ1) a touch-surface-side hard coat, 2: (β) a poly(meth)acrylimide resin film, 3: a pressure-sensitive adhesive layer, 4: (δ) a gas barrier functional layer, 5: (α) an aromatic polycarbonate resin film, and 6: (γ2) a printing-surface-side hard coat.

According to at least one embodiment, the transparent chemically curing adhesive is not especially limited, but examples thereof include chemically curing adhesives such as polyvinyl acetate resins, ethylene-vinyl acetate copolymer resins, polyester resins, polyurethane resins, acrylic resins and polyamide resins. The transparent chemically curing adhesive can be used singly or as a mixture of two or more thereof.

According to at least one embodiment, the transparent pressure-sensitive adhesive is not especially limited, but examples thereof include acrylic pressure-sensitive adhesives, urethane pressure-sensitive adhesives, and silicon pressure-sensitive adhesives. The transparent pressure-sensitive adhesive can be used singly or as a mixture of two or more thereof.

A film of the transparent chemically curing adhesive or the transparent pressure-sensitive adhesive can be formed from the transparent chemically curing adhesive or the transparent pressure-sensitive adhesive using any of web applying methods such as roll coating, gravure coating, reverse coating, roll brushing, spray coating, air knife coating and die coating. At this time, there can be used a known dilution solvent, for example, methyl ethyl ketone, methyl isobutyl ketone, ethyl acetate, n-butyl acetate, isopropanol, 1-methoxy-2-propanol or acetone. Alternatively, the film may be formed by a T die extrusion method. The thickness of the film of the transparent chemically curing adhesive or the transparent pressure-sensitive adhesive is not especially limited, but in consideration of the use of a known film formation method, is usually 0.5 to 200 μm.

According to at least one embodiment, the (δ) gas barrier functional layer is a thin layer including, for example, a metal oxide, a metal nitride, a metal carbide, a metal oxynitride, a metal oxyboride or a mixture/composite thereof. The (δ) gas barrier functional layer develops a high gas barrier property, and is not especially limited as long as being transparent. Examples of the metal oxide include silicon oxide, aluminum oxide, magnesium oxide, titanium oxide, indium oxide, tin oxide, indium tin oxide, tantalum oxide, zirconium oxide and niobium oxide. Examples of the metal nitride include aluminum nitride, silicon nitride and boron nitride. Examples of the metal oxynitride include aluminum oxynitride, silicon oxynitride and boron oxynitride.

According to at least one embodiment, the thickness of the (δ) gas barrier functional layer is, from the viewpoint of the gas barrier property, preferably 10 nm or larger, and more preferably 50 nm or larger. On the other hand, the thickness of the (δ) gas barrier functional layer is, from the viewpoint of the cracking resistance and the transparency, preferably 1,000 nm or smaller, and more preferably 500 nm or smaller.

According to at least one embodiment, the (δ) gas barrier functional layer can be formed by a known method, for example, a chemical vapor deposition method such as a low-temperature plasma chemical vapor deposition method, a plasma chemical vapor deposition method, a thermochemical vapor deposition method or a photochemical vapor deposition method, an ion sputtering method, a vacuum deposition method, an ion plating method, or a combination thereof.

A method for producing the (α) aromatic polycarbonate resin film is not especially limited, but includes, for example, a method comprising the step of (P) continuously extruding a melted film of the (α) aromatic polycarbonate resin film from a T die using an apparatus comprising an extruder and the T die; and (Q) supplying and charging the melted film of the (α) aromatic polycarbonate resin film between a first rotating or circulating mirror-finished body and a second rotating or circulating mirror-finished body and pressing the melted film.

A method for producing the (β) poly(meth)acrylimide resin film is not especially limited, but includes, for example, a method comprising the step of (P′) continuously extruding a melted film of the (β) a poly(meth)acrylimide resin from a T die using an apparatus comprising an extruder and the T die; and (Q′) supplying and charging the melted film of the (β) poly(meth)acrylimide resin between a first rotating or circulating mirror-finished body and a second rotating or circulating mirror-finished body and pressing the melted film.

As the T die used in the step (P) or the step (P′), any one can be used. Examples of the T die include manifold dies, fish tail dies and coat hanger dies.

As the extruder used in the step (P) or the step (P′), any one can be used. Examples of the extruder include single-screw extruders, co-rotating twin-screw extruders and counter-rotating twin-screw extruders.

In order to suppress the deterioration of the (α) aromatic polycarbonate resin and the (β) a poly(meth)acrylimide resin, nitrogen purging in the extruder is preferable. It is preferable that the (α) aromatic polycarbonate resin and the (β) a poly(meth)acrylimide resin are dried before being supplied to film formation. It is also preferable that the (α) aromatic polycarbonate resin and the (β) a poly(meth)acrylimide resin are directly conveyed and charged in the extruder after being dried in a drier. The set temperature of the drier is preferably 100 to 150° C. Further, it is preferable that a vacuum vent is installed on the extruder (usually in a measuring zone at a screw tip).

According to at least one embodiment, the temperature of the T die used in the step (P) is preferably set at 260° C. or more in order to stably perform the extrusion step of the melted film of the (α) aromatic polycarbonate resin. More preferably, the temperature of the T die is 270° C. or more. In addition, in order to suppress the deterioration of the (α), the temperature of the T die is preferably set at 350° C. or less.

According to at least one embodiment, the temperature of the T die used in the step (P′) is preferably set at 260° C. or more in order to stably perform the extrusion step of the melted film of the (β) a poly(meth)acrylimide resin. More preferably, the temperature of the T die is 270° C. or more. In addition, in order to suppress the deterioration of the (β), the temperature of the T die is preferably set at 350° C. or less.

In addition, the ratio (R/T) of the lip opening (R) to the thickness of the obtained (α) aromatic polycarbonate resin film or (β) poly(meth)acrylimide resin film (T) is preferably 10 or less, more preferably 5 or less, from the viewpoint of preventing retardation from increasing. In addition, the ratio (R/T) is preferably 1 or more, more preferably 1.5 or more from the viewpoint of preventing the extrusion load from becoming excessive.

Examples of the first mirror-finished body used in the step (Q) or the step (Q′) include a mirror-finished roll and a mirror-finished belt. In addition, examples of the second mirror-finished body include a mirror-finished roll and a mirror-finished belt.

According to at least one embodiment, the mirror-finished roll is a roll whose surface is mirror-finished. The mirror-finished roll includes those made of metals, ceramics, and silicon rubbers. In addition, the surface of the mirror-finished roll can be subjected to a chrome plating treatment, an iron-phosphorus alloy plating treatment, a hard carbon treatment by PVD or CVD, or the like for the purpose of protection from corrosion and scratching.

According to at least one embodiment, the mirror-finished belt is a seamless belt usually made of a metal whose surface is mirror-finished. The mirror-finished belt is arranged, for example, to loop around a pair of belt rollers and circulate between them. In addition, the surface of the mirror-finished belt can be subjected to a chrome plating treatment, an iron-phosphorus alloy plating treatment, a hard carbon treatment by PVD or CVD, or the like for the purpose of protection from corrosion and scratching.

According to at least one embodiment, the mirror finishing is not limited and can be performed by any method. Examples thereof include a method of performing polishing using fine abrasive grains to set the arithmetic average roughness (Ra) of the surface of the mirror-finished body at preferably 100 nm or less, more preferably 50 nm or less, and set the ten-point average roughness (Rz) at preferably 500 nm or less, more preferably 250 nm or less.

Though there is no intention of being bound by any theory, it can be considered that the (α) aromatic polycarbonate resin film or the (β) poly(meth)acrylimide resin film excellent in transparency, surface smoothness and appearance is obtained by the aforementioned film forming method because the melted film thereof is pressed by the first mirror-finished body and the second mirror-finished body, and thus the highly smooth surface states of the first mirror-finished body and the second mirror-finished body are transferred to the film to correct faulty portions such as die streaks.

In order that the transfer of the surface states is performed well, the surface temperature of the first mirror-finished body is preferably 100° C. or higher. The surface temperature of the first mirror-finished body is more preferably 120° C. or higher, and further preferably 130° C. or higher. On the other hand, in order to prevent the development on the film of appearance faults (exfoliation marks) accompanying the peeling-off from the first mirror-finished body, the surface temperature of the first mirror-finished body is made to be preferably 200° C. or lower, and more preferably 160° C. or lower.

In order that the transfer of the surface states is performed well, the surface temperature of the second mirror-finished body is preferably 20° C. or higher. The surface temperature of the second mirror-finished body is more preferably 60° C. or higher, and further preferably 100° C. or higher. On the other hand, in order to prevent the development on the film of appearance faults (exfoliation marks) accompanying the peeling-off from the second mirror-finished body, the surface temperature of the second mirror-finished body is made to be preferably 200° C. or lower, and more preferably 160° C. or lower.

According to at least one embodiment, the surface temperature of the first mirror-finished body is preferably higher than the surface temperature of the second mirror-finished body. This is because the film is held by the first mirror-finished body and fed to the next transport roll.

(γ) Hard Coat

A hard coat-laminated film according to another embodiment has, as a film substrate, (α) an aromatic polycarbonate resin film in which the content of a structural unit derived from 4,4′-(3,3,5-trimethylcyclohexane-1,1-diyl)diphenol is 30% by mol or larger with the total amount of a structural unit(s) derived from an aromatic dihydroxy compound(s) being taken to be 100% by mol, and has (γ) a hard coat formed on at least one surface of the resin film. In addition, a hard coat-laminated film according to another embodiment has, as a film substrate, a transparent laminated film of (α) an aromatic polycarbonate resin film in which the content of a structural unit derived from 4,4′-(3,3,5-trimethylcyclohexane-1,1-diyl)diphenol is 30% by mol or larger with the total amount of a structural unit(s) derived from an aromatic dihydroxy compound(s) being taken to be 100% by mol with (β) a poly(meth)acrylimide resin film, and has (γ) a hard coat formed on at least one surface of the transparent laminated film. The (γ) hard coat can act to improve the abrasion resistance, the surface hardness, the thermal resistance, the dimensional stability and the rigidity.

One embodiment of the hard coat-laminated film may be one having, in order from the outermost surface layer side, (γ1) a first hard coat; (β) a poly(meth)acrylimide resin layer; (α) an aromatic polycarbonate resin layer comprising a structural unit derived from 4,4′-(3,3,5-trimethylcyclohexane-1,1-diyl)diphenol in an amount of 30% by mol or larger with the total amount of a structural unit(s) derived from an aromatic dihydroxy compound(s) being taken to be 100% by mol; and (γ2) a second hard coat. Here, the “surface layer side” means a side, of an article formed of a hard coat laminate being a multilayer structure, nearer to the outer face when the article is placed in on-site use (i.e. a touch surface in the case of a touch panel display face plate).

According to at least one embodiment, the (γ) hard coat may be formed directly on the (α) aromatic polycarbonate resin film, or may be formed thereon through an anchor coat. In addition, the (γ) hard coat may be formed through an optional resin film such as the (β) poly(meth)acrylimide resin film on the (α) aromatic polycarbonate resin film. In addition, in a coextrusion multilayer film of the (α) aromatic polycarbonate resin with an optional resin such as the (β) poly(meth)acrylimide resin, the (γ) hard coat may be formed through an optional resin layer. Further, the (γ) hard coat may be formed through an optional functional layer such as the (δ) gas barrier functional layer, an antireflective layer or an antiglare layer on the (α) aromatic polycarbonate resin film or a laminated film of the (α) aromatic polycarbonate resin with an optional resin.

A coating material to form the (γ) hard coat is not limited as long as being capable of forming a hard coat with excellent transparency and high difficulty in coloring, and any coating material can be used. A preferable coating material for forming a hard coat includes an active energy ray-curable resin composition.

According to at least one embodiment, the active energy ray-curable resin composition is one capable of being polymerized and cured by active energy rays such as ultraviolet rays and electron beams thereby forming a hard coat. Examples of the active energy ray-curable resin composition include a composition comprising both an active energy ray-curable resin and a compound having two or more isocyanate groups (—N═C═O) in one molecule thereof and/or a photopolymerization initiator.

Examples of the active energy ray-curable resin include resins comprised of one or more members selected from the following groups: (meth)acryloyl group-containing prepolymers or oligomers such as polyurethane (meth)acrylate, polyester (meth)acrylate, polyacryl (meth)acrylate, epoxy (meth)acrylate, polyalkylene glycol poly(meth)acrylate and polyether (meth)acrylate; (meth)acryloyl group-containing monofunctional reactive monomers such as methyl (meth)acrylate, ethyl (meth)acrylate, n-butyl (meth)acrylate, hexyl (meth)acrylate, 2-ethylhexyl (meth)acrylate, lauryl (meth)acrylate, isobornyl (meth)acrylate, dicyclopentenyl (meth)acrylate, dicyclopentenyloxyethyl (meth)acrylate, phenyl (meth)acrylate, phenyl cellosolve (meth)acrylate, 2-methoxyethyl (meth)acrylate, hydroxyethyl (meth)acrylate, hydroxypropyl (meth)acrylate, 2-acryloyloxyethyl hydrogen phthalate, dimethylaminoethyl (meth)acrylate, trifluoroethyl (meth)acrylate and trimethylsiloxyethyl methacrylate; monofunctional reactive monomers such as N-vinylpyrrolidone and styrene; (meth)acryloyl group-containing bifunctional reactive monomers such as diethylene glycol di(meth)acrylate, neopentyl glycol di(meth)acrylate, 1,6-hexanediol di(meth)acrylate, polyethylene glycol di(meth)acrylate, 2,2′-bis(4-(meth)acryloyloxypolyethyleneoxyphenyl)propane and 2,2′-bis(4-(meth)acryloyloxypolypropyleneoxyphenyl)propane; (meth)acryloyl group-containing trifunctional reactive monomers such as trimethylolpropane tri(meth)acrylate and trimethylolethane tri(meth)acrylate; (meth)acryloyl group-containing tetrafunctional reactive monomers such as pentaerythritol tetra(meth)acrylate; and (meth)acryloyl group-containing hexafunctional reactive monomers such as dipentaerythritol hexaacrylate; and resins, as the constitutional monomer(s), having one or more members selected from the above monomers. The active energy ray-curable resin can be used singly or as a mixture of two or more thereof.

In connection with the above illustration, the term meth(acrylate) is herein intended to represent an acrylate or methacrylate.

Examples of the compound having two or more isocyanate groups in one molecule thereof include methylenebis-4-cyclohexyl isocyanate; polyisocyanates such as trimethylolpropane adducts of tolylene diisocyanate, trimethylolpropane adducts of hexamethylene diisocyanate, trimethylolpropane adducts of isophorone diisocyanate, isocyanurates of tolylene diisocyanate, isocyanurates of hexamethylene diisocyanate, isocyanurates of isophorone diisocyanate, and biurets of hexamethylene diisocyanate; and urethane crosslinking agents such as blocked isocyanates of the polyisocyanates. These can be used singly or in a combination of two or more. Further when crosslinking is carried out, as required, there may be added a catalyst such as dibutyltin dilaurate or dibutyltin diethyl hexoate.

Examples of the photopolymerization initiator include benzophenone compounds such as benzophenone, methyl-o-benzoyl benzoate, 4-methylbenzophenone, 4,4′-bis(diethylamino)benzophenone, methyl o-benzoylbenzoate, 4-phenylbenzophenone, 4-benzoyl-4′-methyldiphenyl sulfide, 3,3′,4,4′-tetra(tert-butylperoxycarbonyl)benzophenone and 2,4,6-trimethylbenzophenone; benzoin compounds such as benzoin, benzoin methyl ether, benzoin ethyl ether, benzoin isopropyl ether and benzyl methyl ketal; acetophenone compounds such as acetophenone, 2,2-dimethoxy-2-phenylacetophenone and 1-hydroxycyclohexyl phenyl ketone; anthraquinone compounds such as methylanthraquinone, 2-ethylanthraquinone and 2-amylanthraquinone; thioxanthone compounds such as thioxanthone, 2,4-diethylthioxanthone and 2,4-diisopropylthioxanthone; alkylphenone compounds such as acetophenone dimethyl ketal; triazine compounds; biimidazole compounds; acylphosphine oxide compounds; titanocene compounds; oxime ester compounds; oxime phenylacetate compounds; hydroxyketone compounds; and aminobenzoate compounds. These can be used singly or in a combination of two or more.

According to at least one embodiment, the (γ) hard coat preferably includes an active energy ray-curable resin composition comprising 100 parts by mass of (A) a polyfunctional (meth)acrylate, 0.2 to 4 parts by mass of (B) a compound having an alkoxysilyl group and a (meth)acryloyl group, 0.05 to 3 parts by mass of (C) an organotitanium, and 5 to 100 parts by mass of (D) microparticles having an average particle diameter of 1 to 300 nm. When the (γ) hard coat forms a touch surface (outermost surface) of an image display apparatus, the (γ) hard coat preferably includes an active energy ray-curable resin composition comprising 100 parts by mass of (A) a polyfunctional (meth)acrylate, 0.2 to 4 parts by mass of (B) a compound having an alkoxysilyl group and a (meth)acryloyl group, 0.05 to 3 parts by mass of (C) an organotitanium, 5 to 100 parts by mass of (D) microparticles having an average particle diameter of 1 to 300 nm, and (E) 0.01 to 7 parts by mass of a water repellant. When the (γ) hard coat has such a composition of components, there can be obtained a hard coat-laminated film excellent in transparency, color tone, abrasion resistance, surface hardness, bending resistance and surface appearance, and capable of maintaining surface properties such as finger slidability even if being repeatedly wiped with a handkerchief or the like.

(A) Polyfunctional (Meth)Acrylate

According to at least one embodiment, the polyfunctional (meth)acrylate of component (A) is a (meth)acrylate having two or more (meth)acryloyl groups in one molecule thereof. This compound, since having two or more (meth)acryloyl groups in one molecule thereof, is polymerized and cured by active energy rays such as ultraviolet rays and electron beams thereby acting to form a hard coat. In connection with the above illustration, the term (meth)acryloyl group is herein intended to represent an acryloyl group or a methacryloyl group. The term (meth)acrylate is herein intended to represent an acrylate or a methacrylate.

Examples of the polyfunctional (meth)acrylate include (meth)acryloyl group-containing bifunctional reactive monomers such as diethylene glycol di(meth)acrylate, neopentyl glycol di(meth)acrylate, 1,6-hexanediol di(meth)acrylate, polyethylene glycol di(meth)acrylate, 2,2′-bis(4-(meth)acryloyloxypolyethyleneoxyphenyl)propane and 2,2′-bis(4-(meth)acryloyloxypolypropyleneoxyphenyl)propane; (meth)acryloyl group-containing trifunctional reactive monomers such as trimethylolpropane tri(meth)acrylate and trimethylolethane tri(meth)acrylate; (meth)acryloyl group-containing tetrafunctional reactive monomers such as pentaerythritol tetra(meth)acrylate; (meth)acryloyl group-containing hexafunctional reactive monomers such as dipentaerythritol hexaacrylate; and polymers (oligomers and prepolymers) composed of one or more thereof as constituent monomers. Component (A) can be used singly or as a mixture of two or more thereof.

(B) A Compound Having an Alkoxysilyl Group and a (Meth)Acryloyl Group

According to at least one embodiment, the compound having an alkoxysilyl group and a (meth)acryloyl group of component (B) can chemically bond with or strongly interact with component (A) due to having a (meth)acryloyl group in the molecule; and with component (D) due to having an alkoxysilyl group in the molecule. Component (B) serves to largely improve the abrasion resistance of a hard coat by such chemical bond or strong interaction. Further, due to having a (meth)acryloyl group in the molecule or due to having an alkoxysilyl group in the molecule, component (B) chemically bonds with or strongly interacts with component (E) also. Component (B) also serves to prevent trouble such as bleedout of component (E) by such chemical bond or strong interaction.

Here, component (B) is distinguished from component (A) in that component (B) has an alkoxysilyl group. Component (A) has no alkoxysilyl group. In the present description, a compound having an alkoxysilyl group and two or more (meth)acryloyl groups in one molecule thereof is classified into component (B).

Examples of component (B) include compounds having a chemical structure represented by the general formula “(—SiO₂RR′—)ₙ.(—SiO₂RR″—)ₘ”. Here, n is a natural number (positive integer), and m is 0 or a natural number. Preferably, n is a natural number of 2 to 10, and m is 0 or a natural number of 1 to 10. R is an alkoxy group such as a methoxy group (CH₃O—) and an ethoxy group (C₂H₅O—). R′ is an acryloyl group (CH₂═CHCO—) or a methacryloyl group (CH₂═C(CH₃)CO—). R″ is an alkyl group such as a methyl group (—CH₃) and an ethyl group (—CH₂CH₃).

Examples of component (B) include compounds having a chemical structure represented by each of the general formulae “(—SiO₂(OCH₃)(OCHC═CH₂)—)ₙ”, “(—SiO₂(OCH₃)(OC(CH₃)C═CH₂)—)ₙ”, “(—SiO₂(OCH₃)(OCHC═CH₂)—)ₙ.(—SiO₂(OCH₃)(CH₃)—)ₘ,” “(—SiO₂(OCH₃)(OC(CH₃)C═CH₂)—)ₙ.(—SiO₂(OCH₃)(CH₃)—)ₘ”, “(—SiO₂(OC₂H₅)(OCHC═CH₂)—)ₙ”, “(—SiO₂(OC₂H₅)(OC(CH₃)C═CH₂)—)ₙ”, “(—SiO₂(OC₂H₅)(OCHC═CH₂)—)ₙ.(—SiO₂(OCH₃)(CH₃)—) m”, and “:(—SiO₂(OC₂H₅)(OC(CH₃)C═CH₂)—)ₙ.(—SiO₂(OCH₃)(CH₃)—)ₘ”. Here, n is a natural number (positive integer), and m is 0 or a natural number. Preferably, n is a natural number of 2 to 10, and m is 0 or a natural number of 1 to 10.

Component (B) can be used singly or as a mixture of two or more thereof.

According to at least one embodiment, the blend amount of component (B) is, from the viewpoint of the abrasion resistance, with respect to 100 parts by mass of component (A), 0.2 parts by mass or larger, preferably 0.5 parts by mass or larger, and more preferably 1 part by mass or larger. On the other hand, from the viewpoint of making the water repellency to be easily developed, and from the viewpoint of making the amount of component (C) not to become excessive when the blend ratio between component (B) and component (C) is made to be in a preferable range, the blend amount of component (B) is 4 parts by mass or smaller, preferably 3 parts by mass or smaller, and more preferably 2 parts by mass or smaller.

Further from the viewpoint of making component (B) to chemically bond with or strongly interact with component (D), the blend amount of component (B) is, with respect to 100 parts by mass of component (D), usually 0.2 to 80 parts by mass, preferably 0.5 to 15 parts by mass, and more preferably 2 to 7 parts by mass.

(C) An Organotitanium

The organotitanium of component (C) is a component to aid the function of component (B). From the viewpoint of largely improving the abrasion resistance of a hard coat, component (B) and component (C) exhibit specific favorable affinity. Further, component (C) itself chemically bonds with or strongly interacts with component (D) and the like, and serves to enhance the abrasion resistance of a hard coat.

Examples of the organotitanium include tetra-i-propoxytitanium, tetra-n-butoxytitanium, tetrakis(2-ethylhexyloxy)titanium, titanium-i-propoxyoctylene glycolate, di-i-propoxytitanium bis(acetylacetonate), propanedioxytitanium bis(ethylacetoacetate), tri-n-butoxytitanium monostearate, di-i-propoxytitanium distearate, titanium stearate, di-i-propoxytitanium diisostrearate, (2-n-butoxycarbonylbenzoyloxy)tributoxytitanium and di-n-butoxy-bis(triethanolaminato)titanium; and polymers composed of one or more thereof. Component (C) can be used singly or as a mixture of two or more thereof.

Among these, tetra-i-propoxytitanium, tetra-n-butoxytitanium and tetrakis(2-ethylhexyloxy)titanium and titanium-i-propoxyoctylene glycolate, which are alkoxytitaniums, are preferable from the viewpoint of the abrasion resistance and the color tone.

According to at least one embodiment, the blend amount of component (C) is, from the viewpoint of the abrasion resistance, with respect to 100 parts by mass of component (A), 0.05 parts by mass or larger, preferably 0.1 part by mass or larger, and more preferably 0.2 parts by mass or larger. On the other hand, from the viewpoint of the color tone, the blend amount of component (C) is 3 parts by mass or smaller, preferably 2 parts by mass or smaller, and more preferably 1.5 parts by mass or smaller.

Further, from the viewpoint of effectively aid the function of component (B), the blend amount of component (C) is, with respect to 100 parts by mass of component (B), preferably 5 to 150 parts by mass, and more preferably 20 to 80 parts by mass.

(D) Microparticles Having an Average Particle Diameter of 1 to 300 nm

According to at least one embodiment, the microparticles having an average particle diameter of 1 to 300 nm of component (D) serve to increase the surface hardness of a hard coat. However, component (D) has weak interaction with component (A), and causes the abrasion resistance to become insufficient. Then, by using component (B) capable of chemically bonding with or strongly interacting with both component (A) and component (D), and component (C) aiding the function of component (B), this problem comes to be solved.

Therefore, component (D) is preferably a substance capable of chemically bonding with or strongly interacting with component (B), and more preferably a substance capable of chemically bonding with or strongly interacting with component (B) and component (C).

As component (D), there can be used either of inorganic microparticles and organic microparticles. Examples of the inorganic microparticles include silica (silicon dioxide); metal oxide microparticles such as aluminum oxide, zirconia, titania, zinc oxide, germanium oxide, indium oxide, tin oxide, indium tin oxide, antimony oxide and cerium oxide; metal fluoride microparticles such as magnesium fluoride and sodium fluoride; metal sulfide microparticles; metal nitride microparticles; and metal microparticles. Examples of the organic microparticles include resin beads of styrene resins, acrylic resins, polycarbonate resins, ethylene resins, cured resins of an amino compound with formaldehyde, and the like. These can be used singly or in a combination of two or more.

Any group of these substances exemplified as component (D) can be believed to be at least a substance capable of chemically bonding with or strongly interacting with component (B).

Further, for the purpose of enhancing the dispersibility of the microparticles in a coating material and increasing the surface hardness of an obtained hard coat, there may be used the microparticles treated on the surface thereof with a surface treating agent. Examples of the surface treating agent include a silane coupling agent such as a vinylsilane or an aminosilane; a titanate coupling agent; an aluminate coupling agent; an organic compound having a reactive functional group such as an ethylenic unsaturated bond group such as a (meth)acryloyl group, a vinyl group or an allyl group, or an epoxy group; a fatty acid; a fatty acid metal salt; or the like.

Among these microparticles, in order to obtain a hard coat having a higher surface hardness, microparticles of silica and aluminum oxide are preferable, and microparticles of silica are more preferable. Examples of commercially available silica microparticles include “SNOWTEX” (trade name) of Nissan Chemical Industries, Ltd, and Quattron (trade name) of Fuso Chemical Co., Ltd.

According to at least one embodiment, the average particle diameter of component (D) is 300 nm or smaller from the viewpoint of keeping the transparency of a hard coat and securely attaining the effect of improving the surface hardness of the hard coat. The average particle diameter of component (D) is preferably 200 nm or smaller, and more preferably 120 nm or smaller. Meanwhile, there is especially no lower limit of the average particle diameter, but usually available microparticles are ones of about 1 nm at the finest.

According to at least one embodiment, the average particle diameter of the microparticles, which is herein referred to, is a particle diameter at which the cumulation from the smaller side of the particle diameter becomes 50% by mass in a particle diameter distribution curve measured using a laser diffraction/scattering particle size analyzer “MT3200II” (trade name) of Nikkiso Co., Ltd.

According to at least one embodiment, the blend amount of component (D) is, from the viewpoint of the surface hardness, with respect to 100 parts by mass of component (A), 5 parts by mass or larger, and preferably 20 parts by mass or larger. On the other hand, from the viewpoint of the abrasion resistance and the transparency, the blend amount of component (D) is 100 parts by mass or smaller, preferably 70 parts by mass or smaller, and more preferably 50 parts by mass or smaller.

(E) Water Repellant

When the (γ) hard coat forms a touch surface (outermost surface) of an image display apparatus, it is preferable from the viewpoint of enhancing the finger slidability, the fouling-preventive property and the fouling wiping-off property that the active energy ray-curable resin composition further comprises 0.01 to 7 parts by mass of (E) a water repellant.

Examples of the water repellant include wax water repellants such as paraffin wax, polyethylene wax and acrylic-ethylene copolymer waxes; silicon water repellants such as silicon oils, silicon resins, polydimethylsiloxane and alkylalkoxysilanes; and fluorine-containing water repellants such as fluoropolyether water repellants and fluoropolyalkyl water repellants. Component (E) can be used singly or as a mixture of two or more thereof.

Among these water repellants, from the viewpoint of the water repellant performance, fluoropolyether water repellants are preferable as component (E). From the viewpoint of preventing trouble such as bleedout of component (E) by the chemical bond or the strong interaction of component (A) or component (B) with component (E), as component (E), a water repellant is more preferable which contains a compound having a (meth)acryloyl group and a fluoropolyether group in its molecule (hereinafter, abbreviated to a (meth)acryloyl group-containing fluoropolyether water repellant). As component (E), from the viewpoint of suitably controlling the chemical bond or the strong interaction of component (A) or component (B) with component (E), and highly keeping the transparency and simultaneously developing good water repellency, there may be used a mixture of an acryloyl group-containing fluoropolyether water repellant and a methacryloyl group-containing fluoropolyether water repellant.

According to at least one embodiment, the blend amount of component (E) in the case of being used is, from the viewpoint of preventing trouble such as bleedout of component (E), with respect to 100 parts by mass of component (A), usually 7 parts by mass or smaller, preferably 4 parts by mass or smaller, and more preferably 2 parts by mass or smaller. There is especially no lower limit of the blend amount of component (E) because component (E) is an optional component, but from the viewpoint of attaining desired effects, it is usually 0.01 part by mass or larger, preferably 0.05 parts by mass or larger, and more preferably 0.1 part by mass or larger.

It is preferable from the viewpoint of improving the curability by active energy rays that the active energy ray-curable resin composition including components (A) to (D) or components (A) to (E) further includes a compound having two or more isocyanate groups (—N═C═O) in one molecule thereof and/or a photopolymerization initiator. The explanation of these compounds was made in the above.

As required, the active energy ray-curable resin composition may include one or two or more additives such as antistatic agents, surfactants, leveling agents, thixotropy imparting agents, anti-fouling agents, printability improvers, antioxidants, weather resistance stabilizers, light resistance stabilizers, ultraviolet absorbents, thermal stabilizers, colorants and fillers.

As required, the active energy ray-curable resin composition may include a solvent in order to dilute the resin composition to a concentration facilitating coating. The solvent is not especially limited as long as it does not contribute to reacting with the components of the composition or catalyzing (promoting) self-reactions (including deteriorative reactions) of these components. Examples of the solvent include 1-methoxy-2-propanol, ethyl acetate, n-butyl acetate, toluene, methyl ethyl ketone, methyl isobutyl ketone, diacetone alcohol and acetone.

The active energy ray-curable resin composition can be obtained by mixing and stirring these components.

A method for forming the (γ) hard coat by using a coating material for forming a hard coat including the active energy ray-curable resin composition according to at least one embodiment is not especially limited, and there can be used a known web applying method. The method specifically includes methods such as roll coating, gravure coating, reverse coating, roll brushing, spray coating, air knife coating and die coating.

According to at least one embodiment, the thickness of the (γ) hard coat is not especially limited. The thickness of the (γ) hard coat may be, from the viewpoint of the rigidity, the thermal resistance and the dimensional stability of the hard coat-laminated film according to at least one embodiment, usually 1 μm or larger, preferably 5 μm or larger, more preferably 10 μm or larger, and still more preferably 20 μm or larger. Further, the thickness of the (γ) hard coat may be, from the viewpoint of the cutting processability and the web handleability of the hard coat-laminated film according to the present invention, preferably 100 μm or smaller, and more preferably 50 μm or smaller.

According to at least one embodiment, the hard coat-laminated film has a total light transmittance of 80% or higher as measured according to JIS K7361-1:1997 by using a turbidimeter “NDH2000” (trade name) of Nippon Denshoku Industries Co., Ltd. The hard coat-laminated film, when having a total light transmittance of 80% or higher, can be used suitably as an image display apparatus member. A higher total light transmittance of the hard coat-laminated film is preferable. The total light transmittance is preferably 85% or higher, and more preferably 90% or higher.

According to at least one embodiment, the hard coat-laminated film may have a yellowness index of preferably 3 or lower, more preferably 2 or lower and still more preferably 1 or lower as measured according to JIS K7105:1981 by using a chromaticity meter “SolidSpec-3700” (trade name) of Shimadzu Corp. A lower yellowness index of the hard coat-laminated film is preferable. The hard coat-laminated film, when having a yellowness index of 3 or lower, can be used more suitably as an image display apparatus member.

### EXAMPLES

Hereinafter, the present invention will be described by way of Examples, but the present invention is not limited thereto.

Measurement Methods

(1) Total light transmittance

The total light transmittance was measured according to JIS K7361-1:1997 by using a turbidimeter “NDH2000” (trade name) of Nippon Denshoku Industries Co., Ltd.

(2) Haze

The haze was measured according to JIS K7136:2000 by using a turbidimeter

“NDH2000” (trade name) of Nippon Denshoku Industries Co., Ltd.

(3) Yellowness Index

The yellowness index was measured according to JIS K7105:1981 by using a chromaticity meter “SolidSpec-3700” (trade name) of Shimadzu Corp.

(4) Pencil Hardness

The pencil hardness was measured according to JIS K5600-5-4 by using a pencil “UNI” (trade name) of Mitsubishi Pencil Co., Ltd. under the condition of a load of 750 g.

(5) Shrinkage-starting temperature (dimensional stability against heat)

A temperature-test piece length curve was determined in accordance with JIS K7197:1991, and the lowest temperature among temperatures at inflection points at which an increasing trend in the test piece length (expansion) shifted to a decreasing trend (shrinkage) (the temperature at which the test piece length reached to a local maximum) was estimated as the shrinkage-starting temperature. The thermomechanical analyzer (TMA) “EXSTAR 6100 (trade name)” available from Seiko Instruments Inc. was used for the measurement. A test piece was prepared in a size of 20 mm length and 10 mm width so that the machine direction (MD) of the film corresponded to the longitudinal direction of the test piece. Conditioning of the test piece was performed at a temperature of 23° C.±2° C. and a relative humidity of 50±5% for 24 hours, and conditioning at the maximum temperature to be measured was not performed in order to evaluate dimensional stability as the physical property value of a film. The distance between chucks was set to 10 mm. The temperature program was one in which the temperature was retained at a temperature of 20° C. for 3 minutes and thereafter increased to a temperature of 300° C. at a temperature increase rate of 5° C./min.

As a rough indication, when the shrinkage-starting temperature is 135° C. or lower, the dimensional stability against heat can be evaluated as poor.

(6) Conductive Film Formation Test

The hard coat-laminated film was put in a sputtering apparatus; and moisture and gas components in the hard coat-laminated film and the sputtering apparatus were removed at 60° C. for 120 min by reducing the pressure in the sputtering apparatus so that the degree of vacuum thereof became 5×10⁻⁶ or lower. Then, on a transparent conductive film formation surface (printing surface) of the hard coat-laminated film, a transparent conductive thin film (thickness: 15 nm) composed of an indium-tin composite oxide was formed by using a direct current magnetron sputtering method. The conditions were made to be such that: the target was indium oxide containing 10% by mass of tin oxide; the applied direct current power was 1.0 kW; the center roll temperature was 23° C.; and the argon gas partial pressure during the sputtering was 0.67 Pa. In addition, oxygen gas was made to flow in a trace amount so that the surface resistivity became lowest, and its partial pressure was 7.5×10⁻³ Pa. The hard coat-laminated film having the formed transparent conductive film was taken out from the sputtering apparatus, and subjected to an annealing treatment for 60 min. At this time, the annealing temperature was optimized so that a lower surface resistivity was attained, within limits capable of holding good appearance. The conductive film formability was evaluated in the following criteria.

A: a transparent conductive film having a surface resistivity of 100 Ω/sq or lower could be formed.

B: a transparent conductive film having a surface resistivity of 120 Ω/sq or lower could be formed, but a transparent conductive film having a surface resistivity of 100 Ω/sq or lower could not be formed.

C: a transparent conductive film having a surface resistivity of 140 Ω/sq or lower could be formed, but a transparent conductive film having a surface resistivity of 120 Ω/sq or lower could not be formed.

D: a transparent conductive film having a surface resistivity of 150 Ω/sq or lower could be formed, but a transparent conductive film having a surface resistivity of 140 Ω/sq or lower could not be formed.

E: even a transparent conductive film having a surface resistivity of 150 Ω/sq or lower could not be formed.

(7) Minimum Bending Radius

With reference to Bending Formability (B method) in JIS-K6902:2007, a test piece of the hard coat-laminated film was conditioned at a temperature of 23° C.±2° C. and a relative humidity of 50±5% for 24 hours, and thereafter the test piece was bent to form a curve at a bending temperature of 23° C.±2° C. at a bending line with a direction perpendicular to the machine direction of the aromatic polycarbonate resin film constituting the layer (α) of the hard coat-laminated film so that the hard coat surface of the hard coat-laminated film was on the outer side, and for the resultant, measurement was performed. The radius of the front face of the shaping jig having the smallest radius of the front face among shaping jigs with no crack generated was defined as the minimum bending radius. The “front face” has the same meaning as the term regarding a shaping jig in the B method defined in Paragraph 18.2 in JIS-K6902:2007.

(8) Cutting Processability (Condition of Curved Cutting-Processed Line)

The hard coat-laminated film was provided with a cut hole in true circle with a diameter of 0.5 mm and a cut hole in true circle with a diameter of 0.1 mm by using a router processing machine automatically controlled with a computer. The mill used then was a four-bladed super-hard-alloy mill with nicks that has a cylindrically round tip, and the blade diameter was appropriately selected depending on a portion to be processed. Subsequently, the cut hole with a diameter of 0.5 mm was observed for the cut edge surface visually or with a microscope (100×) and evaluation was performed by using the following criteria. Similarly, the cut hole with a diameter of 0.1 mm was observed for the cut edge surface visually or with a microscope (100×) and evaluation was performed by using the following criteria. The result of the former case and the result of the latter case were listed in this order in the tables below.

⊚: (very good): No crack or burr is found even in microscopic observation.

◯ (good): No crack is found even in microscopic observation but burr is found.

Δ (slightly poor): No crack is found in visual observation but crack is found in microscopic observation.

x (poor): A crack is found even in visual observation.

Raw Materials Used

(α) Aromatic Polycarbonate Resins

(α-1) An aromatic polycarbonate resin containing, as structural units derived from aromatic dihydroxy compounds, 61.2% by mol of BPTMC and 38.8% by mol of BPA (see FIG. 4, measured by ¹H-NMR), and having a melt mass flow rate (measured under the conditions of at 330° C. and at 21.18 N according to ISO1133) of 8 g/10 min.

(α-2) An aromatic polycarbonate resin containing, as structural units derived from aromatic dihydroxy compounds, 38.5% by mol of BPTMC and 61.5% by mol of BPA (see FIGS. 2 and 3, measured by ¹³C-NMR), and having a melt mass flow rate (measured under the conditions of at 330° C. and at 21.18 N according to ISO1133) of 19 g/10 min.

(α′) Comparative Aromatic Polycarbonate Resins

(α′-1) An aromatic polycarbonate resin containing 100% by mol of BPA as a structural unit derived from an aromatic dihydroxy compound and having a melt mass flow rate (measured under the conditions of at 330° C. and at 21.18 N according to ISO1133) of 9 g/10 min.

(α′-2) An aromatic polycarbonate resin containing 16% by mol of BPA as a structural unit derived from an aromatic dihydroxy compound, and 84% by mol of a structural unit (hereinafter, abbreviated to “DMBPA” in some cases) derived from dimethylbisphenol A, and having a melt mass flow rate (measured under the conditions of at 330° C. and at 21.18 N according to ISO1133) of 21 g/10 min.

(A) Polyfunctional (Meth)Acrylates

(A-1) dipentaerythritol hexaacrylate (hexafunctional)

(A-2) ethoxylated trimethylolpropane acrylate (trifunctional)

(B) Compounds Having an Alkoxysilyl Group and a (Meth)Acryloyl Group

(B-1) “Shin-Etsu Silicone KR-513” (trade name; R: a methoxy group, R′: an acryloyl group, R″: a methyl group) of Shin-Etsu Chemical Co., Ltd.

(B-2) “Shin-Etsu Silicone X-40-2655A” (trade name; R: a methoxy group, R′: a methacryloyl group, R″: a methyl group) of Shin-Etsu Chemical Co., Ltd.

(B′) Comparative Components

(B′-1) “Shin-Etsu Silicone KBM-403” (trade name; a compound having an alkoxysilyl group and an epoxy group, and no (meth)acryloyl group) of Shin-Etsu Chemical Co., Ltd.

(B′-2) “Shin-Etsu Silicone KBM-903” (trade name; a compound having an alkoxysilyl group and an amino group, and no (meth)acryloyl group) of Shin-Etsu Chemical Co., Ltd.

(C) Organotitaniums

(C-1) titanium-i-propoxyoctylene glycolate “TOG” (trade name) of Nippon Soda Co., Ltd.

(C-2) tetrakis(2-ethylhexyloxy)titanium “TOT” (trade name) of Nippon Soda Co., Ltd.

(C-3) di-i-propoxytitanium bis(acetylacetonate) “T-50” (trade name) of Nippon Soda Co., Ltd.

(C′) Comparative Component:

(C′-1) tetra-n-propoxyzirconium “ZAA (trade name)” of Nippon Soda Co., Ltd.

(D) Microparticles Having an Average Particle Diameter of 1 to 300 nm

(D-1) silica microparticles having an average particle diameter of 20 nm

(E) Water Repellants

(E-1) an acryloyl group-containing fluoropolyether water repellant “KY-1203” (trade name; solid content: 20% by mass) of Shin-Etsu Chemical Co., Ltd.

(E-2) a methacryloyl group-containing fluoropolyether water repellant “FOMBLIN MT70” (trade name; solid content: 70% by mass) of Solvay Advanced Polymers L.L.C.

(E-3) an acryloyl group-containing fluoropolyether water repellant “Megafac RS-91” (trade name) of DIC Corp.

Other Optional Components

(F-1) a phenyl ketone photopolymerization initiator (1-hydroxycyclohexyl phenyl ketone) “SB-PI714” (trade name) of Shuang-Bang Ind. Corp.

(F-2) 1-methoxy-2-propanol

(F-3) a surface regulator “BYK-399” (trade name) of BYK Japan KK

(F-4) a hydroxyketone photopolymerization initiator (α-hydroxyalkylphenone)

“Irgacure 127” (trade name) of BASF

(γ2) a Coating Material for Forming a Printing-Surface-Side Hard Coat

(γ2-1) a coating material was obtained by mixing and stirring at blend ratios of 65 parts by mass of the (A-1), 35 parts by mass of the (A-2), 1.4 parts by mass of the (B-1), 0.7 parts by mass of the (C-1), 35 parts by mass of the (D-1), 5.3 parts by mass of the (F-1), 95 parts by mass of the (F-2) and 0.5 parts by mass of the (F-3).

### Example 1

By using the (α-1), and with the use of an apparatus equipped with a 50-mm extruder (installed with a W flight screw of L/D=29 and CR=1.86), a T die of 680 mm in die width, and a taking-up machine having a mechanism of pressing a melted film between a mirror-finished roll (i.e. a first mirror-finished body) and a mirror-finished belt (i.e. a second mirror-finished body), a film of 500 μm in thickness and having good surface appearance was obtained. The set conditions at this time were such that the set temperatures of the extruder were C1/C2/C3/AD=280/300/320/320° C.; the set temperature of the T die was 320° C.; the lip opening of the T die was 1.0 mm; the set temperature of the mirror-finished roll was 140° C.; the set temperature of the mirror-finished belt was 120° C., and the pressure of the mirror-finished belt was 1.4 MPa; and the taking-up velocity was 3.6 m/min. The total light transmittance, the haze and the yellowness index were measured. The results are shown in Table 1.

Both surfaces of the obtained film were then subjected to a corona discharge treatment; and by using the (γ2-1) and with the use of a die-type coating apparatus, a hard coat was formed on one surface of the obtained film so that the thickness of the hard coat became 25 μm after the curing. Similarly, by using the (γ2-1) and with the use of a die-type coating apparatus, a hard coat was formed on the other surface so that the thickness of the hard coat became 25 μm after the curing. There was obtained a hard coat-laminated film having no undulations nor flaws, exhibiting no impression of cloudiness even when being held up nearby to light, and having good surface appearance. The tests (1) to (8) described above were carried out for the hard coat-laminated film. The results are shown in Table 1.

### Example 2

Formation and evaluation of physical properties of a hard coat-laminated film were carried out totally in the same method as Example 1 except for using the (α-2) in place of the (α-1). The results are shown in Table 1.

### Example 3

Formation and evaluation of physical properties of a hard coat-laminated film were carried out totally in the same method as Example 1 except for using a mixture of 100 parts by mass of the (α-1) and 200 parts by mass of the (α-2) in place of the (α-1). The results are shown in Table 1.

### Example 1C

Formation and evaluation of physical properties of a hard coat-laminated film were carried out totally in the same method as Example 1 except for using the (α′-1) in place of the (α-1). The results are shown in Table 1.

### Example 2C

Formation and evaluation of physical properties of a hard coat-laminated film were carried out totally in the same method as Example 1 except for using the (α′-2) in place of the (α-1). The results are shown in Table 1.

### Example 3C

Formation and evaluation of physical properties of a hard coat-laminated film were carried out totally in the same method as Example 1 except for using a mixture of 30 parts by mass of the (α-1) and 70 parts by mass of the (α′-1) in place of the (α-1). The results are shown in Table 1.

TABLE 1

| | | Example | Example | Example | Example | Example | Example |
|---|---|---|---|---|---|---|---|
| | | 1 | 2 | 3 | 1C | 2C | 3C |
| (α) Film | BPTMC Content (% by mol) | 61.2 | 38.5 | 46.1 | — | — | 18.4 |
| | BPA Content (% by mol) | 38.8 | 61.5 | 53.9 | 100 | 16 | 81.6 |
| | DMBPA Content (% by mol) | — | — | — | — | 84 | — |
| | Total Light Transmittance % | 90 | 90 | 90 | 90 | 90 | 90 |
| | Haze % | 0.4 | 0.4 | 0.4 | 0.4 | 0.4 | 0.4 |
| | Yellowness Index | 0.2 | 0.2 | 0.2 | 0.2 | 0.2 | 0.2 |
| Evaluation | Total Light Transmittance % | 90 | 90 | 90 | 90 | 90 | 90 |
| Results of | Haze % | 0.5 | 0.5 | 0.5 | 0.5 | 0.5 | 0.5 |
| Physical | Yellowness Index | 0.2 | 0.2 | 0.2 | 0.2 | 0.2 | 0.2 |
| Properties | Pencil Hardness | 3H | 3H | 3H | 4H | 6H | 4H |
| | Shrinkage-starting | 179 | 140 | 155 | 130 | 90 | 135 |
| | Temperature ° C. | | | | | | |
| | Conductive Film | A | B | A | C | E | C |
| | Formation Test | | | | | | |
| | Minimum Bending Radius mm | 27 | 22 | 25 | 20 | 40 | 22 |
| | Cutting Processability | ⊚-⊚ | ⊚-⊚ | ⊚-⊚ | ⊚-⊚ | ⊚-⊚ | ⊚-⊚ |

It has been found out from these results that the hard coat-laminated film according to at least one embodiment can develop physical properties suitable as a substrate for image display apparatuses on which circuits are formed and various devices are arranged.

By contrast, in Example 1C, Example 2C and Example 3C, since the dimensional stability against heat was insufficient, the annealing temperature could not be held high so as to enhance the degree of crystallization of the transparent conductive film and sufficiently lower the surface resistivity.

Measurement Methods

(9) Water Contact Angle

The water contact angle of the touch-surface-side hard coat surface of the hard coat-laminated film was determined by a method of calculating it from a width and a height of a water droplet (see JIS R3257:1999) using an automatic contact angle meter “DSA20” (trade name) of KRUSS GmbH.

(10) Abrasion Resistance (Water Contact Angle after Cotton Wiping)

A test piece of the hard coat-laminated film was prepared in a size of 150 mm length and 50 mm width so that the machine direction of the hard coat-laminated film corresponded to the longitudinal direction of the test piece; the test piece was placed on a Gakushin-type tester in accordance with JIS L0849 so that the touch-surface-side hard coat surface directed to surface; then, a stainless steel plate (10 mm in length, 10 mm in width, 1 mm in thickness) covered with a four-stacked-sheet gauze (medical type 1 gauze of Kawamoto Corp.) was attached to a friction terminal of the Gakushin tester, and set so that the length and width surface of the stainless steel plate was brought into contact with the test piece. A load of 350 g was mounted on the stainless steel plate covered with the gauze; and the hard coat surface of the test piece was rubbed 20,000 times reciprocatingly under the conditions of a moving distance of the friction terminal of 60 mm and a speed of one reciprocation/sec; and thereafter, the water contact angle of the cotton-wiped portion was measured according to the method of (9) described above. When the water contact angle was 100° or larger, the abrasion resistance was judged as good. Further when the water contact angle after the 20,000-times reciprocation was smaller than 100°, the measurements in which the number of times of the reciprocation was altered to 15,000 times and 10,000 times were further carried out; and the abrasion resistance was evaluated according to the following criteria.

⊚ (very good): Even after 20,000 times of the reciprocation, the water contact angle was 100° or larger.

∘ (good): After 15,000 times of the reciprocation, the water contact angle was 100° or larger, but after 20,000 times of the reciprocation, the water contact angle was smaller than 100°.

Δ (slightly poor): After 10,000 times of the reciprocation, the water contact angle was 100° or larger, but after 15,000 times of the reciprocation, the water contact angle was smaller than 100°.

x (poor): After 10,000 times of the reciprocation, the water contact angle was smaller than 100°.

(11) Finger Slidability

The finger slidability was evaluated according to impressions of whether or not the touch-surface-side hard coat surface of the hard coat-laminated film could be desiredly rubbed when being rubbed up and down and right and left or circularly by a forefinger. The test was carried out by 10 test members each, and the case where the test piece could be desiredly rubbed was determined to have scored 2 points; the case where the test piece could be almost desiredly rubbed, 1 point; and the case where the test piece could not be desiredly rubbed including that the finger was caught or otherwise, 0 point, and points of all the test members were totalized and the evaluation was carried out according to the following criteria.

⊚ (good): 16 to 20 points

Δ (slightly poor): 10 to 15 points

x (poor): 0 to 9 points

(12) Finger Slidability after Cotton Wiping

The test and evaluation were carried out as in the (11) finger slidability except for using, as the test sample, the hard coat-laminated film after 20,000-times reciprocating cotton wiping according to the method of (10) described above.

(13) Abrasion Resistance (Steel Wool Resistance)

The hard coat-laminated film was placed on a Gakushin-type tester in accordance with JIS L0849 so that the touch-surface-side hard coat surface of the hard coat-laminated film directed to outer surface. Then, a #0000 steel wool was attached to a friction terminal of the Gakushin tester; thereafter, a load of 500 g was mounted; and the surface of the test piece was rubbed 100 times reciprocatingly. The surface was visually observed and evaluated according to the following criteria.

⊚ (very good): there was no scratches.

◯ (good): there was 1 to 5 scratches.

Δ (slightly poor): there was 6 to 10 scratches.

x (poor): there was 11 or more scratches.

Raw Material Used

(β) a Poly(Meth)Acrylimide Resin Film

(β-1) By using a poly(meth)acrylimide “PLEXIMID TT70” (trade name) of Evonik Degussa GmbH, and with the use of an apparatus equipped with a 50-mm extruder (installed with a W flight screw of L/D=29 and CR=1.86), a T die of 680 mm in die width, and a taking-up machine having a mechanism of pressing a melted film between a mirror-finished roll (i.e. a first mirror-finished body) and a mirror-finished belt (i.e. a second mirror-finished body), a film of 150 μm in thickness and having good surface appearance was obtained. The set conditions at this time were such that the set temperatures of the extruder were C1/C2/C3/AD=280/300/300/300° C.; the set temperature of the T die was 300° C.; the lip opening of the T die was 0.5 mm; the set temperature of the mirror-finished roll was 130° C.; the set temperature of the mirror-finished belt was 120° C., and the pressure of the mirror-finished belt was 1.4 MPa; and the taking-up velocity was 7.8 m/min. Then, the total light transmittance of the film was 93%; the haze was 0.3%; and the yellowness index was 0.6.

### Examples 4 to 18, and Examples 1S to 7S

Each of the surfaces of the film composed of the (α-1) obtained in Example 1 was subjected to corona discharge treatment, and each of the surfaces of the film of the (β-1) was also subjected to a corona discharge treatment; and thereafter, both the films were laminated by using an optical pressure-sensitive adhesive sheet of 25 μm in thickness thereby obtaining a transparent laminated film. Then, on the (α-1) side film surface of the transparent laminated film, by using the (γ2-1) as the coating material for forming a printing-surface-side hard coat and with the use of a die-type coating apparatus, a hard coat was formed so that the thickness of the hard coat became 25 μm after the curing. Further, on the (β-1) side film surface of the transparent laminated film, by using a coating material of a blend composition indicated in one of Tables 2 to 4 as the coating material for forming a touch-surface-side hard coat and with the use of a die-type coating apparatus, a hard coat was formed so that the thickness of the hard coat became 25 μm after the curing. The tests (1) to (13) described above were carried out for each of the hard coat-laminated films. Here, for the tests (3) and (9) to (13), these tests were carried out on the touch-surface-side hard coat. For the test (6), this test was carried out on the printing-surface-side hard coat. Further, for the test (7), this test was carried out such that the laminated film was bent to form a curved surface so that the touch-surface-side hard coat directed to outer surface. The results are shown in one of Tables 2 to 4.

### Example 19

By using an extrusion film-forming apparatus having a coextrusion T die of two-kind three-layer multi-manifold type, and a taking-up machine having a mechanism of pressing a melted film between a mirror-finished roll (i.e. first mirror-finished body) and a mirror-finished belt (i.e., second mirror-finished body), the (α-1) as a middle layer of a transparent laminated film and the poly(meth)acrylimide “PLEXIMID TT70” (trade name) of Evonik Degussa GmbH as both outer layers of the transparent laminated film were coextruded thereby obtaining the transparent laminated film of 550 μm in thickness. At this time, the thickness of the middle layer was 450 μm; the thickness of each of both the outer layers was 50 μm; the set temperature of the mirror-finished roll was 130° C.; the set temperature of the mirror-finished belt was 120° C.; and the taking-up velocity was 6.5 m/min. Then, on the mirror-finished roll-side surface of the transparent laminated film, by using the (γ2-1) as the coating material for forming a printing-surface-side hard coat and with the use of a die-type coating apparatus, a hard coat was formed so that the thickness of the hard coat became 25 μm after the curing. Further, on the mirror-finished belt-side surface of the transparent laminated film, by using a coating material of a blend composition indicated in Table 4 as the coating material for forming a touch-surface-side hard coat and with the use of a die-type coating apparatus, a hard coat was formed so that the thickness of the hard coat became 25 μm after the curing. The tests (1) to (13) described above were carried out for the hard coat-laminated film. Here, for the tests (3) and (9) to (13), these tests were carried out on the touch-surface-side hard coat. For the test (6), this test was carried out on the printing-surface-side hard coat. Further, for the test (7), this test was carried out such that the laminated film was bent to form a curved surface so that the touch-surface-side hard coat directed to outer surface. The results are shown in Table 4.

TABLE 2

| | | Example | Example | Example | Example | Example | Example | Example | Example |
|---|---|---|---|---|---|---|---|---|---|
| | | 4 | 5 | 6 | 7 | 8 | 1S | 1S | 9 |
| Components | A-1 | 65 | 65 | 65 | 65 | 65 | 65 | 65 | 65 |
| of Coating | A-2 | 35 | 35 | 35 | 35 | 35 | 35 | 35 | 35 |
| Material | B-1 | 1.4 | 1.4 | 1.4 | 1.4 | 1.4 | 1.4 | 1.4 | 1.4 |
| (parts by mass) | C-1 | 0.7 | 0.1 | 0.3 | 1.1 | 1.9 | — | 3.5 | 0.7 |
| | D-1 | 35 | 35 | 35 | 35 | 35 | 35 | 35 | 35 |
| | E-1 | 1.6 | 1.6 | 1.6 | 1.6 | 1.6 | 1.6 | 1.6 | — |
| | E-2 | 0.2 | 0.2 | 0.2 | 0.2 | 0.2 | 0.2 | 0.2 | — |
| | E-3 | — | — | — | — | — | — | — | 1.6 |
| | F-1 | 5.3 | 5.3 | 5.3 | 5.3 | 5.3 | 5.3 | 5.3 | 4.6 |
| | F-2 | 95 | 95 | 95 | 95 | 95 | 95 | 95 | 95 |
| | F-4 | — | — | — | — | — | — | — | 0.7 |
| Evaluation | Total Light Transmittance % | 91 | 91 | 91 | 91 | 91 | 91 | 90 | 91 |
| Results of | Yellowness Index | 0.4 | 0.4 | 0.4 | 0.6 | 2.0 | 0.4 | 4.5 | 0.4 |
| Physical | Pencil Hardness | 7H | 6H | 7H | 7H | 7H | 6H | 6H | 7H |
| Properties | Shrinkage-starting | 170 | 170 | 170 | 170 | 170 | 170 | 170 | 170 |
| | Temperature ° C. | | | | | | | | |
| | Conductive Film Formation Test | A | A | A | A | A | A | A | A |
| | Minimum Bending Radius mm | 30 | 30 | 30 | 30 | 30 | 30 | 30 | 30 |
| | Cutting Processability | ⊚-⊚ | ⊚-⊚ | ⊚-⊚ | ⊚-⊚ | ⊚-⊚ | ⊚-⊚ | ⊚-⊚ | ⊚-⊚ |
| | Initial Water Contact Angle deg | 110 | 110 | 110 | 110 | 110 | 110 | 110 | 110 |
| | Water Contact Angle after | 109 | 98 | 102 | 109 | 109 | <90 | 109 | 109 |
| | Cotton Wiping deg | | | | | | | | |
| | Evaluation of the Water Contact | ⊚ | ◯ | ⊚ | ⊚ | ⊚ | Δ | ⊚ | ⊚ |
| | Angle after Cotton Wiping | | | | | | | | |
| | Finger Slidability | ⊚ | ⊚ | ⊚ | ⊚ | ⊚ | ⊚ | ⊚ | ⊚ |
| | Finger Slidability after Cotton | ⊚ | ◯ | ⊚ | ⊚ | ⊚ | X | ⊚ | ⊚ |
| | Wiping | | | | | | | | |
| | Steel Wool Resistance | ⊚ | ⊚ | ⊚ | ⊚ | ⊚ | ⊚ | ⊚ | ⊚ |

TABLE 3

| | | Example | Example | Example | Example | Example | Example | Example | Example |
|---|---|---|---|---|---|---|---|---|---|
| | | 10 | 11 | 12 | 13 | 14 | 15 | 3S | 4S |
| Components | A-1 | 65 | 65 | 65 | 65 | 65 | 65 | 65 | 65 |
| of Coating | A-2 | 35 | 35 | 35 | 35 | 35 | 35 | 35 | 35 |
| Material | B-1 | 0.5 | 1.0 | 2.0 | 3.0 | 1.4 | 1.4 | 1.4 | 0.05 |
| (parts by mass) | C-1 | 0.7 | 0.7 | 0.7 | 1.1 | — | — | — | 0.7 |
| | C-2 | — | — | — | — | 0.7 | — | — | — |
| | C-3 | — | — | — | — | — | 0.7 | — | — |
| | C′-1 | — | — | — | — | — | — | 0.7 | — |
| | D-1 | 35 | 35 | 35 | 35 | 35 | 35 | 35 | 35 |
| | E-1 | 1.6 | 1.6 | 1.6 | 1.6 | 1.6 | 1.6 | 1.6 | 1.6 |
| | E-2 | 0.2 | 0.2 | 0.2 | 0.2 | 0.2 | 0.2 | 0.2 | 0.2 |
| | F-1 | 5.3 | 5.3 | 5.3 | 5.3 | 5.3 | 5.3 | 5.3 | 5.3 |
| | F-2 | 95 | 95 | 95 | 95 | 95 | 95 | 95 | 95 |
| Evaluation | Total Light Transmittance % | 91 | 91 | 91 | 91 | 90 | 90 | 90 | 91 |
| Results of | Yellowness Index | 0.5 | 0.5 | 0.7 | 1.6 | 2.0 | 2.8 | 0.5 | 0.4 |
| Physical | Pencil Hardness | 6H | 7H | 7H | 7H | 7H | 7H | 6H | 5H |
| Properties | Shrinkage-starting | 170 | 170 | 170 | 170 | 170 | 170 | 170 | 170 |
| | Temperature ° C. | | | | | | | | |
| | Conductive Film Formation Test | A | A | A | A | A | A | A | A |
| | Minimum Bending Radius mm | 30 | 30 | 30 | 30 | 30 | 30 | 30 | 30 |
| | Cutting Processability | ⊚-⊚ | ⊚-⊚ | ⊚-⊚ | ⊚-⊚ | ⊚-⊚ | ⊚-⊚ | ⊚-⊚ | ⊚-⊚ |
| | Initial Water Contact Angle deg | 110 | 110 | 110 | 110 | 110 | 110 | 110 | 110 |
| | Water Contact Angle after | 100 | 105 | 109 | 109 | 109 | 109 | <90 | <90 |
| | Cotton Wiping deg | | | | | | | | |
| | Evaluation of the Water Contact | ⊚ | ⊚ | ⊚ | ⊚ | ⊚ | ⊚ | Δ | Δ |
| | Angle after Cotton Wiping | | | | | | | | |
| | Finger Slidability | ⊚ | ⊚ | ⊚ | ⊚ | ⊚ | ⊚ | ⊚ | ⊚ |
| | Finger Slidability after Cotton | ⊚ | ⊚ | ⊚ | ⊚ | ⊚ | ⊚ | X | X |
| | Wiping | | | | | | | | |
| | Steel Wool Resistance | ⊚ | ⊚ | ⊚ | ⊚ | ⊚ | ⊚ | ⊚ | ⊚ |

TABLE 4

| | | Example | Example | Example | Example | Example | Example | Example |
|---|---|---|---|---|---|---|---|---|
| | | 5S | 16 | 17 | 18 | 6S | 7S | 19 |
| Components | A-1 | 65 | 65 | 65 | 65 | 65 | 65 | 65 |
| of Coating | A-2 | 35 | 35 | 35 | 35 | 35 | 35 | 35 |
| Material | B-1 | 4.5 | 1.4 | 1.4 | — | — | — | 1.4 |
| (parts by mass) | B-2 | — | — | — | 1.4 | — | — | — |
| | B′-1 | — | — | — | — | 1.4 | — | — |
| | B′-2 | — | — | — | — | — | 1.4 | — |
| | C-1 | 1.9 | 0.7 | 0.7 | 0.7 | 0.7 | 0.7 | 0.7 |
| | D-1 | 35 | 10 | 50 | 35 | 35 | 35 | 35 |
| | E-1 | 1.6 | 1.6 | 1.6 | 1.6 | 1.6 | 1.6 | 1.6 |
| | E-2 | 0.2 | 0.2 | 0.2 | 0.2 | 0.2 | 0.2 | 0.2 |
| | F-1 | 5.3 | 5.3 | 5.3 | 5.3 | 5.3 | 5.3 | 5.3 |
| | F-2 | 95 | 95 | 95 | 95 | 95 | 95 | 95 |
| Evaluation | Total Light Transmittance % | 90 | 91 | 89 | 90 | 90 | 90 | 91 |
| Results of | Yellowness Index | 2.0 | 0.5 | 0.6 | 0.5 | 0.6 | 4.4 | 0.4 |
| Physical | Pencil Hardness | 7H | 6H | 7H | 6H | 5H | 7H | 7H |
| Properties | Shrinkage-starting | 170 | 170 | 170 | 170 | 170 | 170 | 168 |
| | Temperature ° C. | | | | | | | |
| | Conductive Film Formation Test | A | A | A | A | A | A | A |
| | Minimum Bending Radius mm | 30 | 30 | 40 | 30 | 30 | 30 | 30 |
| | Cutting Processability | ⊚-⊚ | ⊚-⊚ | ⊚-⊚ | ⊚-⊚ | ⊚-⊚ | ⊚-⊚ | ⊚-⊚ |
| | Initial Water Contact Angle deg | 98 | 110 | 110 | 110 | 110 | 110 | 110 |
| | Water Contact Angle after | 97 | 109 | 108 | 100 | <90 | 105 | 109 |
| | Cotton Wiping deg | | | | | | | |
| | Evaluation of the Water Contact | X | ⊚ | ⊚ | ⊚ | Δ | ⊚ | ⊚ |
| | Angle after Cotton Wiping | | | | | | | |
| | Finger Slidability | ⊚ | ⊚ | ⊚ | ⊚ | ⊚ | ⊚ | ⊚ |
| | Finger Slidability after Cotton | ◯ | ⊚ | ⊚ | ⊚ | X | ⊚ | ⊚ |
| | Wiping | | | | | | | |
| | Steel Wool Resistance | ⊚ | ⊚ | ⊚ | ⊚ | ⊚ | ⊚ | ⊚ |

It had been found out from these results that the hard coat-laminated film according to at least one embodiment can develop physical properties suitable as a substrate for image display apparatuses on which circuits are formed and various devices are arranged. Further, it has been also found out that since the hard coat-laminated film is excellent also in the abrasion resistance, the hard coat-laminated film is useful for the one plastic solution in place of the so-called one glass solution.

### REFERENCE SIGNS LIST

1: (γ1) Touch-surface-side hard coat
2: (β) Poly(meth)acrylimide resin film
3: Pressure-sensitive adhesive layer
4: (δ) Gas barrier functional layer
5: (α) Aromatic polycarbonate resin film
6: (γ2) Printing-surface-side hard coat

1. A hard coat-laminated film, comprising:
(α) an aromatic polycarbonate resin film comprising a structural unit derived from 4,4′-(3,3,5-trimethylcyclohexane-1,1-diyl)diphenol in an amount of 30% by mol or larger with a total amount of a structural unit(s) derived from an aromatic dihydroxy compound(s) being taken to be 100% by mol; and
(γ) a hard coat formed on at least one surface of the aromatic polycarbonate resin film,
wherein the hard coat-laminated film has a total light transmittance of 80% or higher.

2. A hard coat-laminated film, comprising:
a transparent laminated film of
(α) an aromatic polycarbonate resin film comprising a structural unit derived from 4,4′-(3,3,5-trimethylcyclohexane-1,1-diyl)diphenol in an amount of 30% by mol or larger with a total amount of a structural unit(s) derived from an aromatic dihydroxy compound(s) being taken to be 100% by mol, with ((3) a poly(meth)acrylimide resin film; and
(γ) a hard coat formed on at least one surface of the transparent laminated film, wherein the hard coat-laminated film has a total light transmittance of 80% or higher.

3. The hard coat-laminated film according to claim 2, wherein the laminated film is formed by laminating the (β) poly(meth)acrylimide resin film, the (α) aromatic polycarbonate resin film, and the (β) poly(meth)acrylimide resin film in this order.

4. The hard coat-laminated film according to claim 1 or 2, wherein the (γ) hard coat is formed from an active energy ray-curable resin composition comprising:
(A) 100 parts by mass of a polyfunctional (meth)acrylate;
(B) 0.2 to 4 parts by mass of a compound having an alkoxysilyl group and a (meth)acryloyl group;
(C) 0.05 to 3 parts by mass of an organotitanium; and
(D) 5 to 100 parts by mass of microparticles having an average particle diameter of 1 to 300 nm.

5. The hard coat-laminated film according to claim 4, wherein the active energy ray-curable resin composition further comprises (E) 0.01 to 7 parts by mass of a water repellant.

6. The hard coat-laminated film according to claim 5, wherein the (E) water repellant comprises a (meth)acryloyl group-containing fluoropolyether water repellant.

7. A hard coat-laminated film, comprising, in order from the outermost surface layer side:
(γ1) a first hard coat;
(β) a poly(meth)acrylimide resin layer;
(α) an aromatic polycarbonate resin layer comprising a structural unit derived from 4,4′-(3,3,5-trimethylcyclohexane-1,1-diyl)diphenol in an amount of 30% by mol or larger with a total amount of a structural unit(s) derived from an aromatic dihydroxy compound(s) being taken to be 100% by mol; and
(γ2) a second hard coat,
wherein the (γ1) first hard coat is formed from an active energy ray-curable resin composition comprising:
(A) 100 parts by mass of a polyfunctional (meth)acrylate;
(B) 0.2 to 4 parts by mass of a compound having an alkoxysilyl group and a (meth)acryloyl group;
(C) 0.05 to 3 parts by mass of an organotitanium;
(D) 5 to 100 parts by mass of microparticles having an average particle diameter of 1 to 300 nm; and
(E) 0.01 to 7 parts by mass of a water repellant, and
wherein the hard coat-laminated film has a total light transmittance of 80% or higher.

8. The hard coat-laminated film according to claim 7, further comprising:
(β) another poly(meth)acrylimide resin layer between the (α) aromatic polycarbonate resin layer and the (γ2) second hard coat.

9. The hard coat-laminated film according to claim 7 or 8, further comprising (δ) a gas barrier functional layer.

10. Use of the hard coat-laminated film according to any one of claims 1, 2, or 7 as an image display apparatus member.

11. An image display apparatus, comprising:
the hard coat-laminated film according to any one of claims 1, 2 or 7.
